(19) United States
(12) Patent Application Publication
(10) Pub. No.: US 2009/0280428 A1
(43) Pub. Date: Nov. 12, 2009

(54) IMAGE FORMATION APPARATUS THAT SOLVES UNEVEN GLOSS IN A PAGE, AND IMAGE FORMATION METHOD AND RECORDING MEDIUM FOR THE METHOD

(75) Inventor: Ryohei MATSUO, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/431,808

(22) Filed: Apr. 29, 2009

(30) Foreign Application Priority Data
May 12, 2008 (JP) 2008-124804

(51) Int. Cl. G03G 13/20; G03G 21/20; G03G 15/20

(52) U.S. Cl. 430/124.3; 399/44; 399/69

(57) ABSTRACT

The present invention reduces delay in supplying heat to fixing nip when sheet passes therethrough and overcomes disadvantages like uneven gloss in page and fixing faults by including temperature detector 83 detecting temperatures of fixing member including heat application roller and fixing belt, leading end detector 85 detecting timing leading end of sheet passes through predetermined position upstream in conveyance path from fixing position by distance portion of fixing belt having been in position heated by heat application part 81 travels to fixing position, and temperature controller 87 performing normal temperature control being on-off control of heat application part 81 based on detected temperature until sheet passes through, keeping heat application part 81 on until detected temperature reaches switching temperature if it exceeds switching temperature and heat application part 81 is off before detection when the sheet passes through and resuming normal temperature control when it reaches predetermined switching temperature.

### BACKGROUND OF THE INVENTION

This application is based on application No. 2008-124804 filed in Japan, the content of which is hereby incorporated by reference.

(1) Field of the Invention

The present invention relates to an image formation apparatus equipped with a fixing device that uses a heat roller fixing method, and particularly relates to technology that appropriately controls a fixing temperature.

(2) Description of the Related Art

Generally, image formation apparatuses using an electronic photographic method in a heat application roller fixing method are divided into a two-roller type fixing device and a belt-type fixing device.

An image formation apparatus having the two-roller type fixing device (i) forms a fixing nip between a heat application roller having a heat source, and a pressure application roller, (ii) passes a recording sheet on which an unfixed image is formed through such the fixing nip, and (iii) bonds the unfixed image on the recording sheet by thermocompression. Compared with the belt type fixing device, the image formation apparatus has a simple structure and is low in the number of components. Therefore, the image formation apparatus is low in price compared with the belt type fixing device.

An image formation apparatus having the belt type fixing device (i) includes an endless belt supported by a heat application roller and a fixing roller instead of the heat application rollers of the two-roller type fixing device, and (ii) forms a fixing nip between the fixing roller and a pressure application roller via the endless belt. Since the thickness of the heat application roller can be reduced compared to the above-mentioned image formation apparatus having the two-roller type fixing device, it is possible, with such the image information apparatus having the belt type fixing device, to shorten the warm-up time. Also, it is possible to adopt, for the fixing roller, a material that can be easily transformed. This widens a nip width, thereby making it possible to accelerate the printing speed.

The temperature of the fixing nip should be kept in a range that is suitable for fixing in the image information apparatus having the belt type fixing device in order to obtain a preferable fixity. Therefore, the image formation apparatus controls an output of a heat source while monitoring the temperature of the heat application roller, for example, with use of a temperature sensor such as a thermistor or the like. However, due to (i) delay in detection caused by a detecting position of the temperature sensor, the sensitivity of the temperature sensor and the like, and (ii) time lag which is a time period from a start of the heat application until the temperature of the fixing nip actually rises, the temperature ripple occurs. Therefore, a fluctuation of temperatures of the fixing nip is caused.

As conventional technology that attempts to solve the above-stated problem, a patent document 1 (Japanese Laid-open patent application publication No. H7-114288) discloses a temperature controlling method of a fixing device. This method (i) performs correction calculation for the delay in detection of the temperature sensor welded to a heat application roller with pressure, and calculation of proportional control with an offset electric power, and (ii) calculates an amount of electric power to be applied to the halogen lamp heater based on the calculation result. With this method, the temperature is stabilized such that the temperature becomes, with high accuracy, a target temperature while reducing a temperature ripple of the heat application roller and a steady-state error. Therefore, it is possible to obtain a stable fixing state constantly and shortening a warm-up time.

Also, a patent document 2 (Japanese Laid-open patent application publication No. H8-241011) discloses the following image formation apparatus. The image formation apparatus counts the number of sheets to be printed after turning on a power. If the counted number of sheets is small, the image formation apparatus lengthens duration of forcibly keeping a heater on. If the counted number of sheets is large, the image formation apparatus shortens duration of forcibly keeping the heater on. Also, after a certain amount of time has passed after the completion of the printing, the image formation apparatus resets the counted number. This prevents deterioration in printing quality due to fluctuation of fixing temperatures at the time of printing a first sheet, and prevents an error due to an abnormal high temperature and breakage of the fixing device.

Also, a patent document 3 (Japanese Laid-open patent application publication No. 11-161089) discloses an image formation apparatus including a fixing device as shown below. The fixing device starts continuous current application to a heating element when receiving an instruction for fixing processing, and stops the continuous current application (i) a predetermined time before a recording medium reaches a fixing nip, or (ii) when the recording medium reaches a predetermined position before the fixing nip. This can prevent deterioration in finished quality such as fixing faults caused when a heat application temperature is low, and gloss faults caused when the heat application temperature is high.

Also, a patent document 4 (Japanese Laid-open patent application publication No. 2006-163011) discloses the following image formation apparatus. The image formation apparatus performs temperature control of a heater by changing an amount of electrical power supplied to the heater based on temperature information of the temperature sensor until the recording sheet reaches a fixing roller. When the recording sheet reaches the fixing roller, the image formation apparatus switches to an operation of supplying a predetermined amount of electrical power to the heater regardless of the temperature information of the temperature sensor. This allows (i) the amount of heat that a recording sheet absorbs from a fixing roller by contacting with the recording sheet, and (ii) an amount of heat of the fixing roller applied by the heater to cancel each other out. This keeps a temperature within a range that allows the toner to be stably fixed on the recording sheet even if the heat of the fixing roller is absorbed by the recording sheet. Therefore, it is possible to reliably prevent undershoot of the temperature of the fixing roller when the recording sheet passes through the fixing roller, and to stably fix a toner on the recording sheet.

However, in the above-stated belt method, since a heat source is positioned distant from the fixing nip, it is difficult to stabilize the temperature of the fixing nip even if a temperature sensor is provided in a vicinity of the heat source.

In order to solve such a problem, there is an idea of controlling temperatures by providing a fixing nip with a temperature sensor. However, adopting a contact type sensor possibly deteriorates an image quality. Also, the temperature control is commonly performed with rotation of an endless belt and the like stopped in a standby mode in order to save power and prevent noise and the like. Accordingly, a sensor is needed in a vicinity of the heat source, which undesirably increases the number of sensors.

For example, in a case where a temperature on an endless belt in a vicinity of a heat application roller is detected, and a temperature control is performed based on this temperature, the following problems arise. About a half a belt worth of delay occurs until the temperature of the fixing nip actually rises even if the heat source is turned on so as to increase a temperature of the fixing nip with the endless belt rotating. Furthermore, a belt worth of delay occurs until arise in temperature is detected. Also, a temperature of the fixing nip rapidly decreases since a large amount of heat is absorbed by a sheet when the sheet passes through the fixing nip in forming an image. In detecting such decrease in the temperature of the fixing nip, a delay occurs. As a result, a delay occurs in heat supply when a sheet passes through the fixing nip. This causes uneven gloss in a page and fixing faults at the trailing ends of sheets.

### SUMMARY OF THE INVENTION

In view of the above-stated problems, the first objective of the present invention is to provide an image formation apparatus capable of solving a problem which is a delay in supplying heat to the fixing nip when a sheet passes through the fixing nip, and overcoming disadvantages such as uneven gloss in a page and fixing faults, while having a belt-type fixing device.

Also, the second objective of the present invention is to provide an image formation method executed in the above-stated image formation apparatus.

Furthermore, the third objective of the present invention is to provide a recording medium storing therein an image formation program executed in the above-stated image formation apparatus.

The above-stated first objective is achieved by an image formation apparatus that (i) includes a fixing member including (a) a heat application roller and (b) a fixing belt that is wound around the heat application roller such that a portion of the fixing belt in a heat application position is heated by a heat source via the heat application roller, and (ii) thermally fixes, with use of the fixing member, an unfixed image formed on a recording sheet conveyed along a conveyance path to a fixing position that is a position to which the portion of the fixing belt travels to supply heat to the unfixed image, the image formation apparatus comprising: a temperature detector operable to detect a temperature of the fixing member; a leading end detector operable to detect a timing that a leading end of the recording sheet passes through a predetermined position on the conveyance path, the predetermined position being a position located upstream in the conveyance path from the fixing position by a distance that is equivalent to a distance that a portion of the fixing belt that has been heated in the heat application position travels to the fixing position; and a temperature controller operable to perform (i) a first temperature control which is an on-off control of the heat source based on the temperature detected by the temperature detector, and (ii) a second temperature control for keeping the heat source on until the detected temperature reaches the predetermined switching temperature, wherein the temperature controller (i) performs the first temperature control until the leading end detector detects that the leading end of the recording sheet has passed through the predetermined position, (ii) performs the second temperature control in a case when the leading end detector detects that the leading end of the recording sheet has passed through the predetermined position if (a) the detected temperature does not exceed a predetermined switching temperature, and (b) the heat source is off, and (iii) resumes the first temperature control in a case when the detected temperature reaches the predetermined switching temperature.

Also, the above-stated second objective is achieved by an image formation method used in an image formation apparatus that detects a temperature of a fixing member with use of a temperature detector, so as to thermally fixes, with use of the fixing member, an unfixed image formed on a recording sheet conveyed along a conveyance path to a fixing position, the fixing member including (a) a heat application roller and (b) a fixing belt that is wound around the heat application roller such that a portion of the fixing belt in a heat application position being heated by a heat source via the heat application roller, and the fixing position being a position to which the portion of the fixing belt travels to supply heat to the unfixed image, the image formation method comprising: a leading end detecting step of detecting a timing that a leading end of the recording sheet passes through a predetermined position on the conveyance path, the predetermined position being a position located upstream in the conveyance path from the fixing position by a distance that is equivalent to a distance that a portion of the fixing belt that has been heated in the heat application position travels to the fixing position; and a temperature controlling step of performing (i) a first temperature control which is an on-off control of the heat source based on the temperature detected by the temperature detecting step, and (ii) a second temperature control for keeping the heat source on until the detected temperature reaches the predetermined switching temperature, wherein the temperature controlling step (i) performs the first temperature control until the leading end detecting step detects that the leading end of the recording sheet has passed through the predetermined position, (ii) performs the second temperature control in a case when the leading end detecting step detects that the leading end of the recording sheet has passed through the predetermined position if (a) the detected temperature does not exceed a predetermined switching temperature, and (b) the heat source is off, and (iii) resumes the first temperature control in a case when the detected temperature reaches the predetermined switching temperature.

Also, the above-stated third objective is achieved by a computer readable recording medium that provides an image formation program that causes an image formation apparatus to form an image, the image formation apparatus detecting a temperature of a fixing member with use of a temperature detector, so as to thermally fixes, with use of the fixing member, an unfixed image formed on a recording sheet conveyed along a conveyance path to a fixing position, the fixing member including (a) a heat application roller and (b) a fixing belt that is wound around the heat application roller such that a portion of the fixing belt in a heat application position being heated by a heat source via the heat application roller, and the fixing position being a position to which the portion of the fixing belt travels to supply heat to the unfixed image, the image formation program causing a computer to perform: a temperature controlling step of performing (i) a first temperature control which is an on-off control of the heat source based on the temperature detected by the temperature detecting step, and (ii) a second temperature control for keeping the heat source on until the detected temperature reaches the predetermined switching temperature, wherein the temperature controlling step (i) performs the first temperature control until the leading end detecting step detects that the leading end of the recording sheet has passed through the predetermined position, (ii) performs the second temperature control in a case when the leading end detecting step detects that the leading end of the recording sheet has passed through the predetermined position if (a) the detected temperature does not exceed a predetermined switching temperature, and (b) the heat source is off, and (iii) resumes the first temperature control in a case when the detected temperature reaches the predetermined switching temperature.

With the above-stated image formation apparatus, image formation method, and recording medium, it is possible to supply heat to a fixing position (fixing nip or the like) from a portion of the fixing belt which has been heated, when the leading end of the recording sheet reaches the fixing position. This suppresses a drop in temperatures of a fixing belt, a fixing position and the like due to a load imposed when a sheet passes through the fixing nip. Also, these temperatures will not excessively rise since an upper limit is set for the temperatures so as not to exceed a predetermined switching temperature.

Accordingly, the present invention is capable of solving a problem which is a delay in supplying heat to the fixing nip when a sheet passes through the fixing nip, and overcoming disadvantages such as uneven gloss in a page and fixing faults, while having a belt-type fixing device.

Also, the image formation apparatus may further include a sheet detector operable to detect whether or not the recording sheet is passing through a certain position located upstream from the fixing position on the conveyance path, wherein the temperature controller may (i) further perform, after the leading end detector has performed the detection, the second temperature control if (a) a time period during which the heat source is off exceeds a predetermined specified time period while the sheet detector is detecting that the recording sheet is passing through the certain position, and (b) the temperature detected by the temperature detector does not exceed the predetermined switching temperature, and (ii) resume the first temperature control in a case when the detected temperature reaches the predetermined switching temperature.

With such the image formation apparatus, even if the temperature controller turns off the heat source because the detected temperature exceeds the target temperature after having turned on the heat source once when a sheet has passed through, the temperature controller turns on the heat source again if a time period during which the heat source is off exceeds a specified time period that possibly causes the fixing faults of the trailing end of the sheet. This can eliminate the fixing faults of the trailing ends of long sheets larger than A3-sized sheets, for example.

Also, according to the image formation apparatus, when performing the first temperature control, the temperature controller may (i) turn off the heat source in one of: a case when the temperature detected by the temperature detector is within a set temperature range, and is rising; and a case when the detected temperature exceeds an upper limit of the set temperature range, and (ii) turn on the heat source in one of: a case when the detected temperature is within the set temperature range, and is decreasing; and a case when the detected temperature is below a lower limit of the set temperature range.

With such the image formation apparatus, at the time of normal temperature control except for when a sheet passes through (i.e. before the leading end of the recording sheet passes through the predetermined position), or after the detected temperature reaches a predetermined switching temperature after the sheet passes through, the temperature controller does not perform the on-off switching of the heat source based on only the detected temperature, but performs the on-off switching of the heat source based on whether the detected temperature is rising or decreasing. Therefore, it is possible to stabilize the temperature in the fixing position even when the belt-type fixing device is used in which a delay occurs (i) before a rise in the temperature is detected after the start of the heat application, or (ii) before a drop in the temperature is detected after the heat application is stopped.

Also, according to the image formation apparatus, the predetermined switching temperature may be a target temperature in a vicinity of a center of the set temperature range, and in a case when the leading end detector detects that the leading end of the recording sheet has passed through the predetermined position, the temperature controller may continue to perform the first temperature control in at least one of a case when the detected temperature exceeds the target temperature, and a case when the heat source is on.

This prevents excessive rise in the temperature of the fixing position since the temperature controller resumes (i) the normal temperature control if the temperature detected after the sheet has passed through exceeds the target temperature in a vicinity of the center of the set temperature range, and (ii) continues to perform the normal temperature control if the heat source is on when the leading end of the recording sheet reaches the predetermined position.

Also, according to the image formation apparatus, the predetermined switching temperature may be a target temperature in a vicinity of a center of the set temperature range, in a case when the leading end detector detects that the leading end of the recording sheet has passed through the predetermined position, the temperature controller may (i) perform the second temperature control if the detected temperature does not exceed the target temperature, and the heat source is on, and (ii) resume the first temperature control in a case when the detected temperature reaches the target temperature, and in a case when the leading end detector detects that the leading end of the recording sheet has passed through the predetermined position, the temperature controller continues to perform the first temperature control if the detected temperature exceeds the target temperature.

This prevents the temperature of the fixing position from rising excessively while suppressing a drop in the temperatures of the fixing belt and the fixing position, caused due to a load imposed when the sheet has passed through the fixing nip since the temperature controller (i) resumes the normal temperature control if the temperature detected after the sheet passes through the fixing nip exceeds the target temperature in a vicinity of the center of the set temperature range, (ii) stops performing the normal temperature control even if the heat source is on when the leading end of the recording sheet reaches the predetermined position, and (iii) keeps the heat source on until the detected temperature reaches the target temperature.

Also, according to the image formation apparatus, the predetermined switching temperature may be an upper limit of the set temperature range, and in a case when the leading end detector detects that the leading end of the recording sheet has passed through the predetermined position, the temperature controller may continue to perform the first temperature control in at least one of (i) a case when the detected temperature exceeds the upper limit of the set temperature range, and (ii) a case when the heat source is on.

This prevents the temperature of the fixing position from rising excessively since the temperature controller (i) resumes the normal temperature control if the temperature detected after the sheet has passed through exceeds the upper limit of the set temperature range, and (ii) continues to perform the normal temperature control if the heat source is on when the leading end of the recording sheet reaches the predetermined position.

Also, according to the image formation apparatus, the predetermined switching temperature may be an upper limit of the set temperature range, in a case when the leading end detector detects that the leading end of the recording sheet has passed through the predetermined position, the temperature controller may (i) perform the second temperature control if the detected temperature does not exceed the upper limit of the set temperature range, and the heat source is on, and (ii) resume the first temperature control in a case when the detected temperature reaches the upper limit of the set temperature range, and in a case when the leading end detector detects that the leading end of the recording sheet has passed through the predetermined position, the temperature controller continues to perform the first temperature control if the detected temperature exceeds the upper limit of the set temperature range.

This can prevent the temperature of the fixing position from rising excessively while suppressing a drop in the temperatures of the fixing belt and the fixing position, caused due to a load imposed when the sheet has passed through since the temperature controller (i) resumes the normal temperature control if the temperature detected after the sheet has passed through exceeds the upper limit of the set temperature range, and (ii) stops performing the normal temperature control even if the heat source is on when the leading end of the recording sheet reaches the predetermined position, and (iii) keeps the heat source on until the detected temperature reaches the target temperature.

Also, the image formation method may further comprise a sheet detecting step of detecting whether or not the recording sheet is passing through a certain position located upstream from the fixing position on the conveyance path, wherein the temperature controlling step may (i) further perform, after the leading end detecting step has performed the detection, the second temperature control if (a) a time period during which the heat source is off exceeds a predetermined specified time period while the sheet detecting step is detecting that the recording sheet is passing through the certain position, and (b) the temperature detected by the temperature detecting step does not exceed the predetermined switching temperature, and (ii) resume the first temperature control in a case when the detected temperature reaches the predetermined switching temperature.

Also, according to the image formation method, when performing the first temperature control, the temperature controlling step may (i) turn off the heat source in one of: a case when the temperature detected by the temperature detecting step is within a set temperature range, and is rising; and a case when the detected temperature exceeds an upper limit of the set temperature range, and (ii) turn on the heat source in one of: a case when the detected temperature is within the set temperature range, and is decreasing; and a case when the detected temperature is below a lower limit of the set temperature range.

Furthermore, according to the image formation method, the predetermined switching temperature may be a target temperature in a vicinity of a center of the set temperature range, and in a case when the leading end detecting step detects that the leading end of the recording sheet has passed through the predetermined position, the temperature controlling step may continue to perform the first temperature control in at least one of a case when the detected temperature exceeds the target temperature, and a case when the heat source is on.

Also, according to the image formation method, the predetermined switching temperature may be a target temperature in a vicinity of a center of the set temperature range, in a case when the leading end detecting step detects that the leading end of the recording sheet has passed through the predetermined position, the temperature controlling step may (i) perform the second temperature control if the detected temperature does not exceed the target temperature, and the heat source is on, and (ii) resume the first temperature control in a case when the detected temperature reaches the target temperature, and in a case when the leading end detecting step detects that the leading end of the recording sheet has passed through the predetermined position, the temperature controlling step may continue to perform the first temperature control if the detected temperature exceeds the target temperature.

Also, according to the image formation method, the predetermined switching temperature may be an upper limit of the set temperature range, and in a case when the leading end detecting step detects that the leading end of the recording sheet has passed through the predetermined position, the temperature controlling step may continue to perform the first temperature control in at least one of (i) a case when the detected temperature exceeds the upper limit of the set temperature range, and (ii) a case when the heat source is on.

Furthermore, according to the image formation method, the predetermined switching temperature may be an upper limit of the set temperature range, in a case when the leading end detecting step detects that the leading end of the recording sheet has passed through the predetermined position, the temperature controlling step may (i) perform the second temperature control if the detected temperature does not exceed the upper limit of the set temperature range, and the heat source is on, and (ii) resume the first temperature control in a case when the detected temperature reaches the upper limit of the set temperature range, and in a case when the leading end detecting step detects that the leading end of the recording sheet has passed through the predetermined position, the temperature controlling step may continue to perform the first temperature control if the detected temperature exceeds the upper limit of the set temperature range.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 shows an overall structure of an image formation apparatus in a first embodiment;

FIG. 2 schematically shows a structure of a fixing member;

FIG. 3 shows a functional structure of the image formation apparatus in the first embodiment;

FIG. 4 shows an outline of the fixing member and a vicinity thereof for explaining a heat start correspondence position;

FIG. 5A shows an outline of the relationship between a detected temperature detected by a temperature detector 83 and on-off states of a heat application part 81 when a temperature controller 87 performs only a first temperature control, and FIG. 5B shows an outline of the relationship between a detected temperature detected by the temperature detector 83 and on-off states of the heat application part 81 when the temperature controller 87 performs the first temperature control and a second temperature control, switching therebetween;

FIG. 6 shows procedures for controlling a temperature at the time of fixing in the first embodiment;

FIG. 7 shows procedures for a first temperature control subroutine in the first embodiment;

FIG. 8A shows observation results obtained after having actually measured a temperature of a fixing belt 53 and on-off states of a heater 55 when, for comparison, the temperature controller 87 performed only the first temperature control without performing the second temperature control when a sheet passes through, and FIG. 8B shows observation results obtained after having actually measured a temperature of the fixing belt 53 and on-off states of the heater 55 when the temperature controller 87 performed the first and second temperature control in the first embodiment, switching therebetween;

FIG. 9 shows procedures for controlling a temperature at the time of fixing in a first modification;

FIG. 10 shows procedures for controlling a temperature at the time of fixing in a modification 2; and

FIG. 11 shows procedures for controlling a temperature at the time of fixing in a modification 3.

### DESCRIPTION OF THE PREFERRED EMBODIMENTS

### First Embodiment

Outline

The first embodiment describes an image formation apparatus including a belt-type fixing device having a feature of solving a problem which is a delay in supplying heat to the fixing nip when a sheet passes through the fixing nip by (i) specifying a heat start correspondence position which is located upstream in a conveyance path of a recording sheet from a fixing nip, and (ii) performing the temperature control for turning on a heat source under a predetermined condition in synchronization with timing that a leading end of the recording sheet passes through the heat start correspondence position such that a portion of the belt having been heated reaches the fixing nip when the recording sheet reaches the fixing nip.

Structure

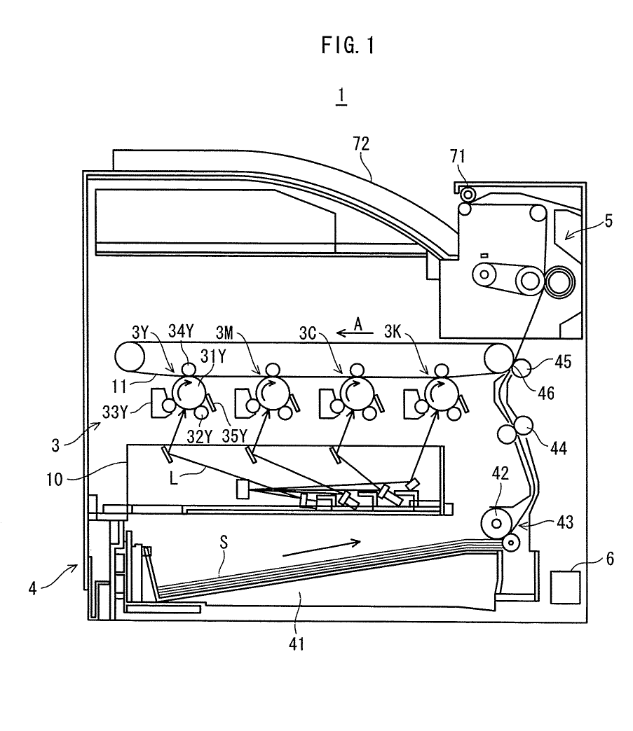

FIG. 1 shows an overall structure of an image formation apparatus in the first embodiment.

As shown in FIG. 1, the image formation apparatus 1 in the first embodiment is a tandem-type full-color digital printer that includes an image processor 3, a feeder 4, a fixing member 5 and a controller 6. Also, the image formation apparatus 1 in the first embodiment is connected to a network (e.g. in-company LAN), and forms and outputs, upon receiving a print-execution instruction from an in-company terminal device, a color image on a recording sheet according to the instruction.

The image processor 3 has a main function of forming an image. In the image processor 3, image formation units 3Y, 3M, 3C and 3K forming yellow, magenta, cyan and black toners respectively are arranged in order along an intermediate transfer belt 11 that rotates in a direction shown by an arrow A. Below the respective image formation units is located an optical part 10 including light-emitting elements such as a laser diode. Note that in the image processor 3, an image formation unit mainly consisting of an element whose reference number has attached thereafter “Y” forms a yellow toner image. Similarly, image formation units mainly consisting of elements whose reference number have attached thereafter “M”, “C” and “K” form a magenta toner image, a cyan toner image and a black toner image, respectively.

The image formation unit 3Y includes a photosensitive drum 31Y, as well as a charger 32Y, a developer 33Y, a primary transfer roller 34Y and a cleaner 35Y that are provided in a vicinity of the photosensitive drum 31Y.

In generation of the yellow toner image, the following procedures are performed. Firstly, the charger 32Y uniformly charges the photosensitive drum 31Y. Secondly, the optical part 10 emits a laser beam L to the uniformly charged photosensitive drum 31Y according to control performed by the controller 6 to form a static latent image. Thirdly, the developer 33 Y develops the formed static latent image with use of the yellow toner. Fourthly, the developed toner image is primarily transferred to the intermediate transfer belt 11. Lastly, the cleaner 35Y removes a toner left on the photosensitive drum 31Y after the primary transfer.

The image formation units 3M, 3C, and 3K also have similar structures (reference numerals thereof are omitted in the drawings) to the image formation unit 3Y, and similarly generate images in each respective color of toner.

Each time the toner image primarily transferred to the intermediate transfer belt 11 passes through one of the image formation units, the color of a toner corresponding to the image formation unit is superimposed over the toner image, so that ultimately a full color toner image is generated.

The feeder 4 has a main function of conveying a recording sheet, and includes a paper feed cassette 41 for housing therein a recording sheet S, a supply roller 42 for supplying the recording sheet S housed in the paper feed cassette 41 to a conveyance path 43 one at a time, a timing roller pair 44 for adjusting a timing of conveying the recording sheet S, and a secondary transfer roller 45. The feeder 4 conveys the recording sheet S to a secondary transfer position 46, and the full-color toner image formed on the intermediate transfer belt 11 is secondarily transferred to the secondary transfer position 46.

The fixing member 5 is a belt-type fixing member that applies heat and pressure to the recording sheet S to which the toner image has been secondarily transferred to fix the toner images on the recording sheet S. The following describes the details of the fixing member 5.

The recording sheet S on which the toner images have been fixed is ejected to an eject tray 72 by the operation of an eject roller 71 or the like.

The controller 6 correctively controls all the operations of the image formation apparatus 1, a temperature adjustment and the like. The controller 6 generates an operation signal for the light-emitting element in the optical part 10 separately for each of the image formation units, based on data on an image to be formed. Also, the controller 6 accurately superimposes the toner images of the respective colors in the primary transfer, and adjusts timing such that the toner images are accurately transferred to the recording sheet S in the secondary transfer.

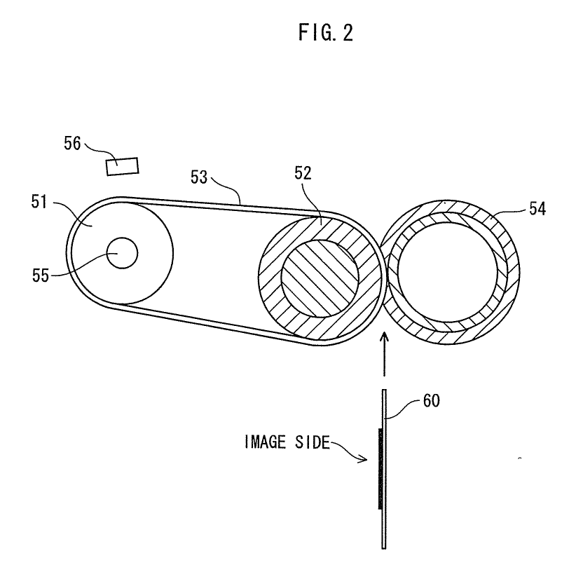

FIG. 2 schematically shows a structure of the fixing member 5.

As shown in FIG. 2, the fixing member 5 forms a fixing nip in a contact portion of a fixing belt 53 and a pressure application roller 54 by: arranging the pressure application roller 54 in a vicinity of a fixing roller 52 via the fixing belt 53 which is wound around a heat application roller 51 and the fixing roller 52 so as to be rotatably supported; and applying a load to the pressure application roller 54 and the fixing roller 52. The fixing member 5 causes the recording sheet on which an unfixed image has been formed to pass through the fixing nip, and bonds the unfixed image to the recording sheet by thermocompression.

The heat application roller 51 is formed by layering a coating layer and the like composed of fluoride resin or the like, on a surface of a cylindrical steel or aluminum pipe (for example, 25 mm outer diameter, 0.6 mm of aluminum metal having a hollow core+a 15μ PTFE coat, a 330 mm nip length extending along a direction of an axis of the fixing roller 52) in order to prevent friction with the fixing belt 53. When applying tensile force to the fixing belt 53 along with the fixing roller 52, the heat application roller 51 drives the rotation of the fixing belt 53 in accordance with the speed at which the recording sheet is passing through.

Also, the heater 55 which is a heat source (for example, a 990 W halogen lamp heater having a 290 mm (sum of 20 mm, 250 mm and 20 mm) luminous length, and heater flux distribution 115%, 100% and 115%) is inserted in the heat application roller 51. The heat application roller 51 is directly heated by heat generated by the heater 55, the heat is transmitted to the fixing belt 53, and the fixing belt 53 is heated to a fixing temperature.

The fixing roller 52 is formed by layering an elastic layer of silicon rubber, sponge or the like on a surface of cylindrical steel or aluminum (for example, 30 mm outer diameter, a φ22 mm steel solid core metal+4 mm of rubber+2 mm of sponge, a 330 mm nip length extending along the direction of the axis of the fixing roller 52). The fixing roller 52 is not directly heated by the heat generated by the heater 55.

The fixing belt 53 is formed of multilayers such as a coating layer composed of fluoride resin or the like, and an elastic layer of silicon rubber or the like on a surface of a heat-resistant layer composed of polyimide resin or nickel base material or the like, and so the fixing belt 53 has flexibility (for example, 60 mm outer diameter, 45 μm of nickel base material+200 μm of rubber+30 μm of PFA, a 320 mm nip length extending along the direction of the axis of the fixing roller 52).

The pressure application roller 54 is formed of multilayers, such as an elastic layer of silicon rubber or the like and a mold release layer composed of fluoride resin or the like on a surface of a cylindrical pipe made of steel or aluminum (for example, 35 mm outer diameter, 2.5 mm of steel metal having a hollow core+2.5 mm of rubber+30 μm of PFA, a 330 mm nip length extending along a direction of an axis of the fixing roller 52).

Also, the fixing member 5 shown in FIG. 2 further includes the non-contact thermistors 56 (for example, disposed at two positions which are respectively located 40 mm and 140 mm from a reference position in a center of an area that a sheet passes through), and outputs voltage corresponding to the surface temperatures of the heat application roller 51 in a vicinity of the heat application roller 51. Alternatively, the non-contact thermistors 56 may be located in any positions in which the temperature of the heat application roller 51 is detected.

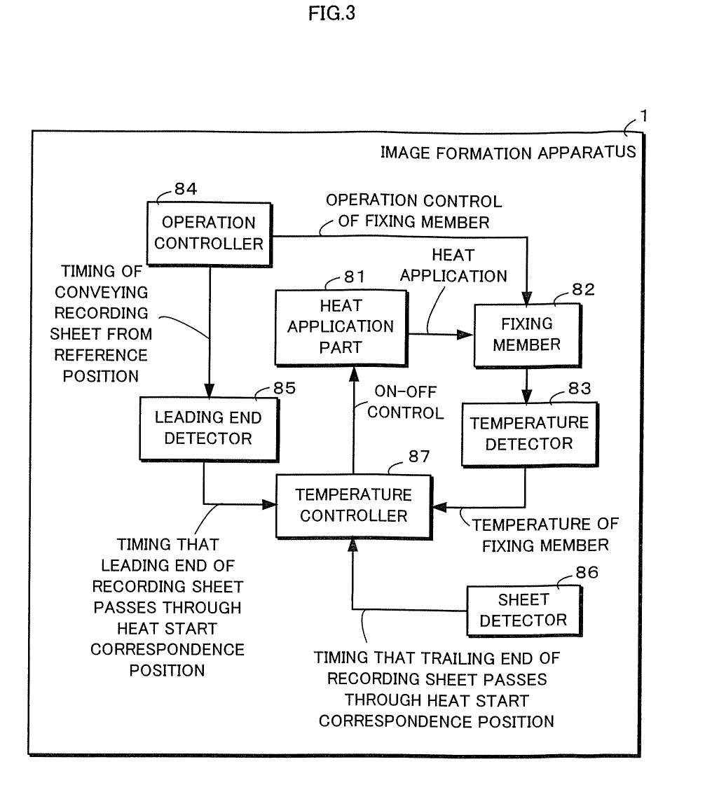

FIG. 3 shows a functional structure of the image formation apparatus 1 in the first embodiment.

As shown in FIG. 3, the image formation apparatus 1 includes a heat application part 81, a fixing member 82, a temperature detector 83, an operation controller 84, a leading end detector 85, a sheet detector 86 and a temperature controller 87.

The heat application part 81 corresponds to the heater 55 shown in FIG. 2, and is a heat source that heats the fixing member 82. The temperature controller 87 performs the on-off control of the heat source.

The fixing member 82 corresponds to the heat application roller 51, the fixing roller 52, the fixing belt 53, the pressure application roller 54 and the like, and is heated by the heat application part 81. Also, the fixing member 82 applies heat and pressure to the recording sheet in the fixing nip.

The temperature detector 83 corresponds to the non-contact thermistor 56 shown in FIG. 2, and detects a temperature of the fixing member 82.

The operation controller 84 (i) corresponds to part of the function the controller 6 shown in FIG. 1 has, (ii) controls conveyance of the recording sheets, a operation of the fixing member 82 and the like, and (iii) notifies the leading end detector 85 of timing of conveying the recording sheet from a predetermined reference position.

The leading end detector 85 (i) corresponds to part of the function the controller 6 shown in FIG. 1 has, (ii) detects timing that the leading end of the recording sheet passes through the heat start correspondence position based on the notification from the leading end detector 85, and (iii) notifies the temperature controller 87 of the timing.

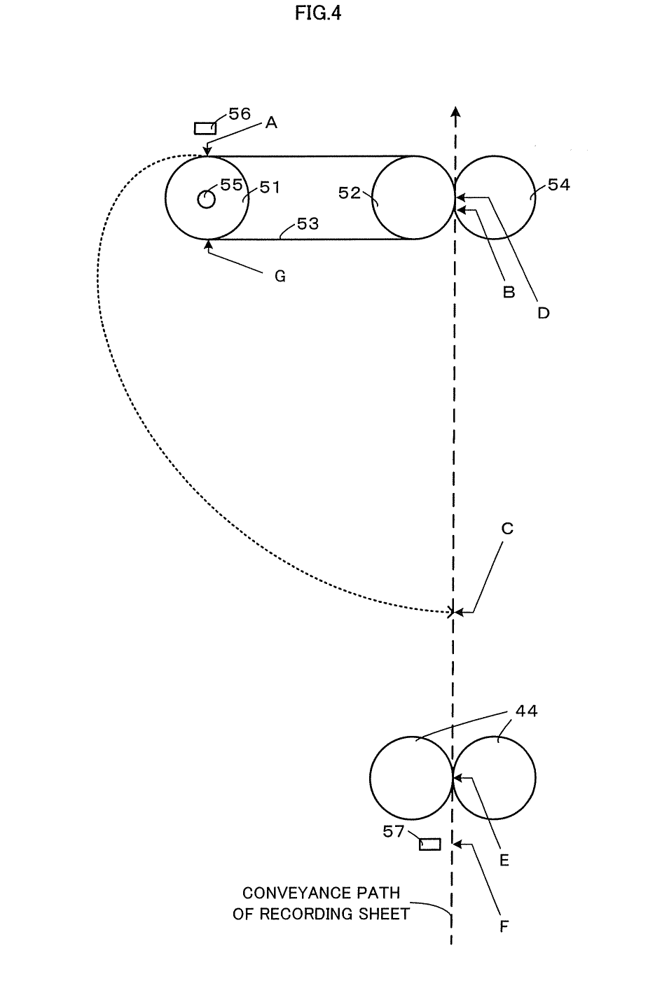

FIG. 4 shows an outline of the fixing member 5 and a vicinity thereof for describing the heat start correspondence position. In FIG. 4 are drawn a timing roller pair 44 and a sheet sensor 57 in addition to the heat application roller 51, the fixing roller 52, the fixing belt 53, the pressure application roller 54, the heater 55 and the non-contact thermistors 56 as shown in FIG. 2.

The heat start correspondence position is a position (C in FIG. 4) upstream in the conveyance path of the recording sheet from a fixing start position (the beginning of a fixing nip) (B in FIG. 4) by a distance equivalent to a distance that a portion of the fixing belt 53 having been in a heat start position of the heater 55 (A in FIG. 4) travels to the fixing start position (shown conceptually by a broken curved line in FIG. 4).

When a length of the belt is 65φ×Π (mm), an outer circumference of the heat application roller is 30×φ×Π (mm), a nip width of a fixing nip is 9 mm, and a linear speed of the fixing belt 53 and the linear speed of the recording sheet are the same, the heat start correspondence position is a position upstream from the contact position of the pressure application roller and the fixing roller by a distance obtained by the following equation (distance between B and C in FIG. 4).

However, a central position of the nip width of the fixing nip corresponds to a contact position of the fixing roller 52 and the pressure application roller 54 in the conveyance path of the recording sheet (straight dashed line in FIG. 4) (D in FIG. 4).

$$\begin{matrix}( Distance between B and C ) = ( belt length \times \frac{1}{2} ) + \\ ( outer circumference of the \\ heat application roller of the \\ heat application roller \times \frac{1}{4} ) - \\ ( nip width \times \frac{1}{2} ) \\ = ( 65 \times Π \times \frac{1}{2} ) + ( 30 \times Π \times \frac{1}{4} ) - \\ ( 9 \times \frac{1}{2} ) \\ \approx 102.05 + 23.55 - 4.5 \\ = 121.1 ( mm )\end{matrix} \qquad equation 1$$

In the first embodiment, the operation controller 84 conveys the recording sheet with rotation of the timing roller pair 44 stopped, checks whether the recording sheet has passed through using the sheet sensor 57, stops the leading end of the recording sheet at the contact position of the timing controller pair 44 (E in FIG. 4), and adjust a timing of forming an image by rotating the timing roller pair 44 at an appropriate timing in synchronization with the respective image formation units. Then the operation controller 84 notifies the leading end detector 85 of timing of starting to rotate the timing roller pair 44 as timing that the leading end of the recording sheet passes through the contact position of the timing roller pair 44 (E in FIG. 4).

Also, since a distance of a section between (i) the contact position of the fixing roller 52 and the pressure application roller 54 (D in FIG. 4) and (ii) the contact position of the timing roller pair 44 (E in FIG. 4) is 210 mm, the heat start correspondence position (C in FIG. 4) is a position located downstream from the reference position by a distance obtained from the following equation 2 (distance between E and C in FIG. 4) when the contact position of the timing roller pair 44 is a reference position (0 mm).

$$\begin{matrix}( Distance between E and C ) = ( distance of a section ) - \\ ( nip width \times 1 / 2 ) - \\ ( distance between B and C \\ obtained by the equation 1 ) \\ = 210 - ( 9 \times 1 / 2 ) - 121.1 \\ = 84.4 ( mm )\end{matrix} \qquad equation 2$$

Accordingly, the leading end detector 85 receives the notification from the operation controller 84 when the recording sheet is conveyed from the contact position (E in FIG. 4) of the timing controller pair 44. The leading end detector 85 (i) judges that the leading end of the recording sheet has reached the heat start correspondence position (C in FIG. 4), based on the notification, when an amount of time corresponding to an amount of time taken to convey the recording sheet by 84.4 (mm) has elapsed, and (ii) notifies the temperature controller 87 that the leading end of the recording sheet has reached the heat start correspondence position (C in FIG. 4).

The sheet detector 86 corresponds to part of functions included in the sheet sensor 57 shown in FIG. 4 and a controller 6 shown in FIG. 1. The sheet detector 86 detects whether the recording sheet is passing through or not with use of a sensor located upstream in the conveyance path from a fixing position. In the first embodiment, the sheet detector 86 (i) detects that a trailing end of the recording sheet has passed through a position (F in FIG. 4) at which the sheet sensor 57 is located, (ii) judges that the leading end of the recording sheet has passed through the heat start correspondence position (C in FIG. 4), based on the notification, when an amount of time corresponding to an amount of time taken to convey the recording sheet from the position (F in FIG. 4) at which the sheet sensor 57 is located to the heat start correspondence position (C in FIG. 4) has elapsed, and (iii) notifies the temperature controller 87 that the trailing end of the recording sheet has passed through the heat start correspondence position (C in FIG. 4).

Note that although the number of sensors is reduced, in the first embodiment, by using the sheet sensor 57 provided conventionally for other purposes without providing a sensor exclusively for detecting timing that the leading and trailing ends of the recording sheet has passed through the heat start correspondence position, a sensor exclusively for detecting such a timing may be provided in the heat start correspondence position (C in FIG. 4). When such the sensor is provided in the heat start correspondence position, the leading end detector 85 can directly detect the leading end of the recording sheet with use of the sensor, and the sheet detector 86 can directly detect the trailing end of the recording sheet with use of the sensor. This makes the detecting processing easy.

The temperature controller 87 corresponds to part of the function included in the controller 6 shown in FIG. 1. The temperature controller 87 performs a first temperature control which is an on-off control on the heat application part 81 based on a temperature detected by the temperature detector 83: when in a standby state; or until the leading end detector 85 detects that the leading end of the recording sheet has passed through the heat start correspondence position.

In the first temperature control, the temperature controller 87 turns off the heat application part 81 in one of (i) a first case when the detected temperature detected by the temperature detector 83 is within a set temperature range, and is rising; and (ii) a second case when the detected temperature exceeds an upper limit of the set temperature range. In the first temperature control, the temperature controller 87 turns on the heat application part 81 in one of: (i) a third case when the detected temperature is within the set temperature range, and is decreasing; and (ii) a fourth case when the detected temperature is below a lower limit of the set temperature range.

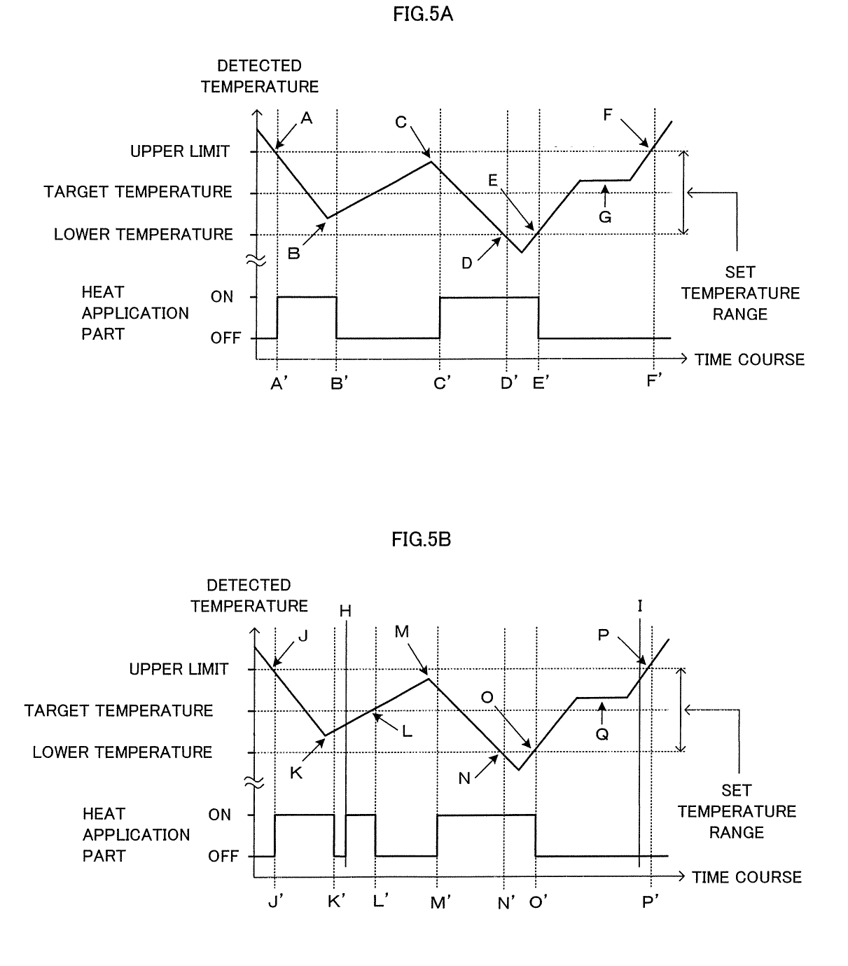

FIG. 5A shows an outline of the relationship between the detected temperature detected by the temperature detector 83 and on-off states of the heat application part 81 when the temperature controller 87 performs the first temperature control.

FIG. 5A shows the following relationship between the detected temperature and on-off states of the heat application part 81 when the temperature controller 87 performs only the first temperature control. (1) Since the detected temperature exceeds an upper limit of the set temperature range (a) in a time period until the temperature reaches a point A, and (b) during a time period from a point F onwards in a linear graph of the detected temperature (upper linear graph) in FIG. 5A (the above-stated second case), the heat application part 81 is off (a) in a time period until the temperature reaches a corresponding point A′, and (b) during a time period from a corresponding point F′ onwards in a linear graph of the heat application part 81 (lower linear graph). (2) Similarly, since the detected temperature is within the set temperature range, and is decreasing (the third case) during a time period between points A and B, and a time period between points C and D, the heat application part 81 is on during a time period between corresponding points A′ and B′, and a time period between corresponding points C′ and D′ in FIG. 5A. (3) Since the detected temperature is within the set temperature range, and is rising (the first case) during a time period between points B and C, and a time period between points E and F in FIG. 5A, the heat application part 81 is off during a time period between corresponding points B′ and C′, and a time period between corresponding points E′ and F′ in FIG. 5A. (4) Since the detected temperature is below the lower limit of the set temperature range during a time period between D and E (the fourth case), the heat application part 81 is on during a time period between corresponding points D′ and E′.

Also, in order to avoid performing on-off switching excessively frequently, the temperature controller 87 does not perform the on-off switching so that the heat application part 81 remains in the same state, when there is no change in the detected temperature (point G in FIG. 5A) in the first case or the third case. As a result, time lag occurs when the temperature controller 87 switches (i) from the first case to the third case (points C and C′ in FIG. 5A), and (ii) from the third case to the first case (points B and B′ in FIG. 5A).

Also, the temperature controller 87 performs the second temperature control for keeping the heat application part 81 on until the detected temperature reaches a target temperature in the following cases at the time when the leading end detector 85 detects that the leading end of the recording sheet has passed through the heat start correspondence position: (i) a case when the detected temperature detected by the temperature detector 83 does not exceed the target temperature which is in a vicinity of a center of the set temperature range; and (ii) a fifth case when the heat application part 81 is off immediately before the detection (i.e. the first case and when the temperature is low in the immediately preceding first temperature control). Subsequently, when the detected temperature reaches the target temperature, the temperature controller 87 resumes the first temperature control.

Also, the temperature controller 87 continues to perform the first temperature control in one of the following cases at the time when the leading end detector 85 detects that the leading end of the recording sheet has passed through the heat start correspondence position: (i) a sixth case when the detected temperature detected by the temperature detector 83 exceeds the target temperature (i.e. the first case and when the temperature is high in the immediately preceding first temperature control, or the second case in the immediately preceding first temperature control); and (ii) a seventh case when the heat application part 81 is on immediately before the detection (i.e. the third case in the immediately preceding first temperature control, or the fourth case in the immediately preceding first temperature control).

FIG. 5B shows an outline of the relationship between a detected temperature detected by the temperature detector 83 and on-off states of the heat application part 81 when the temperature controller 87 performs the first temperature control and the second temperature control, switching therebetween. Each of points H and I in FIG. 5B is when the leading end detector 85 detects that the leading end of the recording sheet has passed through the heat start correspondence position.

As shown in FIG. 5B, the temperature controller 87 performs the first temperature control until the leading end detector 85 detects that the leading end of the recording sheet has passed through the heat start correspondence position, and the following describes the relationship between the detected temperature and the on-off states of the heat application part 81. (1) Since the detected temperature exceeds the upper limit of the set temperature range during a time period until the temperature reaches a point J in a linear graph (upper linear graph) of the detected temperature (the second case), the heat application part 81 is off during a time period until the temperature reaches a corresponding point F′. (2) Similarly, since the detected temperature is within the set temperature range during a time period between points J and K in FIG. 5B, and is decreasing (the third case), the heat application part 81 is on during a time period between corresponding points J′ and K′. (3) Since the detected temperature is within the set temperature range and is rising during a time period between points K and H in FIG. 5B (the first case), the heat application part 81 is off during a time period between corresponding points K′ and H′ in FIG. 5B. (4) Since the detected temperature does not exceed the target temperature, and the heat application part 81 is off immediately before the detection during a time period between points H and L in FIG. 5B (a fifth case) when the leading end detector detects that the leading end of the recording sheet has passed through the heat start correspondence position (point H in FIG. 5B), the temperature controller 87 switches to the second temperature control, and keeps the heat application part 81 on during a time period between corresponding points H′ and I′ in FIG. 5B until the detected temperature reaches the target temperature. (5) The temperature controller 87 resumes the first temperature control when the detected temperature reaches the target temperature, and since the detected temperature is within the set temperature range, and is rising (the first case) in a time period between points L and M in FIG. 5B, the heat application part 81 is off during a time period between corresponding points L′ and M′ in FIG. 5B. (6) Since the detected temperature is within the set temperature range during a time period between points M and N in FIG. 5B, and is decreasing (the third case), the heat application part 81 is on during a time period between corresponding points M′ and N′ in FIG. 5B. (7) Since the detected temperature is below the lower limit of the set temperature range during a time period between points N and O in FIG. 5B (the fourth case), the heat application part 81 is on during a time period between corresponding points N′ and O′ in FIG. 5B. (8) Since the detected temperature is within the set temperature range during a time period between points O and I in FIG. 5B, and is rising (the first case), the heat application part 81 is off during a time period between corresponding points O′ and I′ in FIG. 5B. (9) Since the detected temperature exceeds the target temperature when the leading end detector 85 detects that the leading end of the recording sheet has passed through the heat start correspondence position (point I in FIG. 5B) during a time period between points I and P in FIG. 5B (the sixth case), the heat application part 81 is off during a time period between corresponding points I′ and P′ in FIG. 5B because the temperature controller 87 continues to perform the first temperature control. (10) Since the detected temperature exceeds the upper limit of the set temperature range during a time period from a point P onwards in FIG. 5B (the second case), the heat application part 81 is off during a time period from a corresponding point P′ onwards in FIG. 5B.

Also, as with the case in FIG. 5A, in order to avoid performing the on-off switching excessively frequently, the temperature controller 87 does not perform the on-off switching so that the heat application part remains in the same state, when there is no change in the detected temperature (a point Q in FIG. 5B) in the first case or the third case. As a result, time lag occurs when the temperature controller 87 switches (i) from the first case to the third case (points M and M′ in FIG. 5B), and (ii) from the third case to the first case (K and K′ in FIG. 5B).

Furthermore, in order to eliminate the fixing faults in the trailing ends of long sheets such as A3-sized sheets, the temperature controller 87 performs the following operations after the leading end detector 85 detects that the leading end of the recording sheet has passed through the heat start correspondence position. The temperature controller 87 counts a time period during which the heat application part 81 is off (i) while the sheet detector 86 is detecting that the recording sheet is passing through or (ii) before the sheet detector 86 detects that the trailing end of the recording sheet has passed through the heat start correspondence position. The temperature controller 87 judges whether the detected temperature detected by the temperature detector 83 exceeds the target temperature when the counted time period exceeds a predetermined specified time period (two seconds in the first embodiment). When the detected temperature does not exceed the target temperature, the temperature controller 87 stops performing the first temperature control, and performs the second temperature control. Subsequently, the temperature controller 87 resumes the first temperature control when the detected temperature reaches the target temperature.

Operations

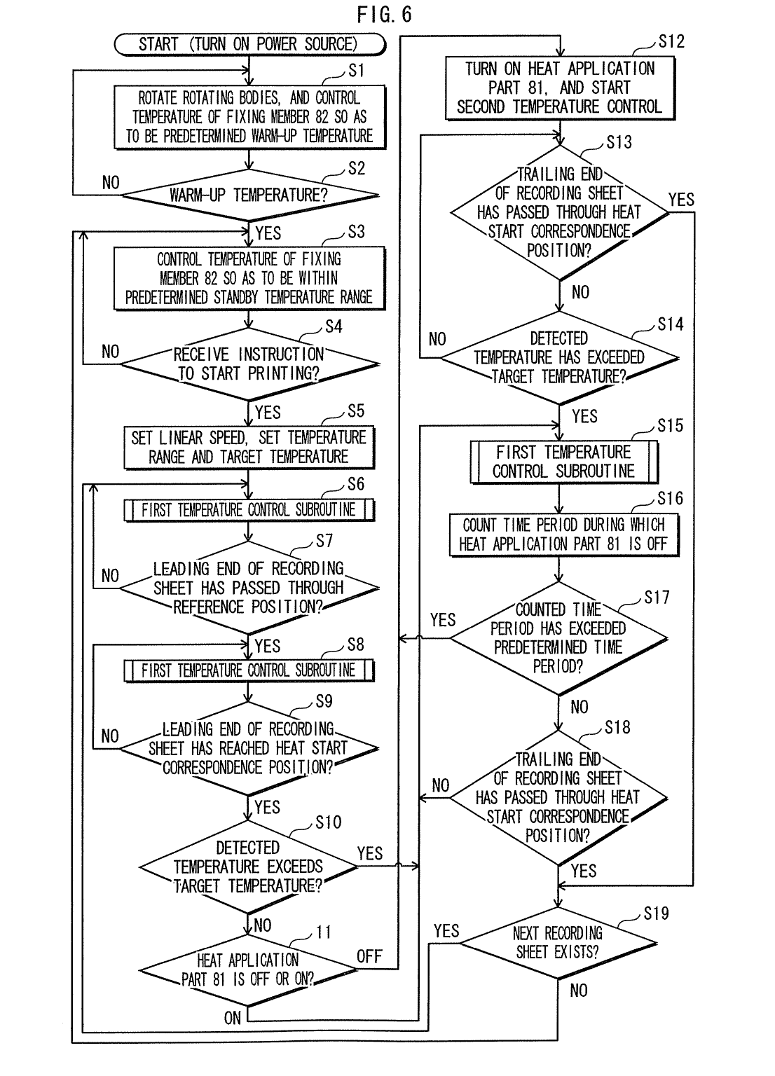

FIG. 6 shows procedures for controlling a temperature at the time of fixing in the first embodiment.

The following describes the procedures for controlling a temperature at the time of fixing, using FIG. 6.

(1) When a power source is turned on, the operation controller 84 rotates predetermined times rotating bodies relating to the fixing, such as the heat application roller 51, the fixing roller 52, the fixing belt 53 and the pressure application roller 54. The temperature controller 87 controls such that a temperature of the fixing member 82 reaches a predetermined warm-up temperature (Step S1).

(2) The temperature controller 87 waits until the temperature of the fixing member 82 reaches the predetermined warm-up temperature (Step S2). In the first embodiment, the temperature controller 87 waits (Step S2) until the detected temperature detected by the temperature detector 83 reaches 185° C. even once.

(3) When the temperature of the fixing member 82 reaches the warm-up temperature (Step S2: YES), the warm up is complete. Then the temperature controller 87 controls the temperature of the fixing member 82 so as to be kept within a predetermined standby temperature range, and falls into a standby state (Step S3). In the first embodiment, the temperature controller 87 controls such that the temperature of the fixing member 82 is kept within a range of 185° C. plus or minus 3° C.

(4) The operation controller 84 waits until receiving, directly from the user or via a PC (personal computer) or the like, an instruction to start printing (Step S4).

(5) Receiving the instruction to start printing (Step S4: YES), the operation controller 84 sets: a linear speed of the fixing belt 53; the linear speed of the recording sheet; the set temperature range in the first temperature control; and the target temperature, according to the material of the recording sheet and a finished specification (normal, high-gloss or the like). Then the temperature controller 87 resumes the first temperature control (Step S5). In the first embodiment, when setting the specification to the normal printing using a normal sheet, the operation controller 84 sets: the linear speed of the fixing belt and the recording sheet to 90 mm/s; the set temperature range to a range of 175° C. and 195° C.; and the target temperature to 185° C. When setting the specification to the gloss printing using a normal sheet, the operation controller 84 sets: the linear speed of the fixing belt 53 and the recording sheet to 45 mm/s; the set temperature range to a range of 135° C. and 155° C.; and the target temperature to 145° C.

(6) The temperature controller 87 performs the first temperature control (the first temperature control subroutine: Step S6).

(7) The operation controller 84 waits until the leading end of the recording sheet passes through the reference position (contact position of the timing roller pair 44: E in FIG. 4) (Step S7).

(8) Even after the leading end of the recording sheet has passed through the reference position (Step S7: YES), the temperature controller 87 continues to perform the first temperature control (the first temperature control subroutine: Step S8).

(9) After the leading end of the recoding sheet has passed through the reference position (Step S7: YES), the temperature controller 87 waits until a time corresponding to a time taken for conveying the recording sheet by 84.4 (mm) has elapsed, and the leading end detector 85 detects that the leading end of the recording sheet has reached the heat start correspondence position (C in FIG. 4) (Step S9).

(10) When the leading end of the recording sheet has reached the heat start correspondence position (C in FIG. 4) (Step S9: YES), the temperature controller 87 judges whether the detected temperature detected by the temperature detector 83 exceeds the target temperature or not (Step S10) For example, in the case of printing with normal setting with use of normal sheet, for example, the temperature controller 87 judges whether or not the detected temperature exceeds 185° C.

(11) When the detected temperature dose not exceed the target temperature (Step S10: NO), the temperature controller 87 judges whether the heat application part 81 is off or on (Step S11).

(12) When the heat application part 81 is off (Step S11: OFF), the temperature controller 87 turns on the heat application part 81, and resumes the second temperature control (Step S12).

(13) The sheet detector 86 judges whether or not the trailing end of the recording sheet has passed through the heat start correspondence position (C in FIG. 4) (Step S13).

(14) If the trailing end of the recording sheet has not passed through the heat start correspondence position (Step S13: NO), the temperature controller 87 waits until the temperature detected by the temperature detector 83 exceeds the target temperature (Step S14).

(15) The temperature controller 87 performs the first temperature control (the first temperature control subroutine: Step S15) in one of the following cases at the time when the leading end of the recording sheet has reached the heat start correspondence position (Step S9: YES): (i) the detected temperature exceeds the target temperature (Step S10: YES); (ii) the detected temperature does not exceed the target temperature (Step S10: NO) while the heat application part 81 is on (Step S11: ON); and (iii) the detected temperature exceeds the target temperature due to the second temperature control (Step S14: NO).

(16) The temperature controller 87 counts a time period during which the heat application part is off (Step S16).

(17) The temperature controller 87 judges whether the counted time period exceeds a time which has been pre-specified (Step S17). When the counted time period exceeds the predetermined specified time period, the temperature controller 87 returns to Step S12.

(18) When the counted time period does not exceed the predetermined specified time period (Step S17: NO), the temperature controller 87 waits for the trailing end of the recording sheet to pass through the heat start correspondence position (C in FIG. 4) (Step S18).

(19) When the trailing end of the recording sheet has passed through the heat start correspondence position (Step S13: YES or Step S18: YES), the sheet detector 86 judges whether the next recording sheet to form an image on exists or not (Step S19). When the next recording sheet exists, the temperature controller 87 returns to Step S6. When the next recording sheet does not exist, the temperature controller 87 returns to Step S3.

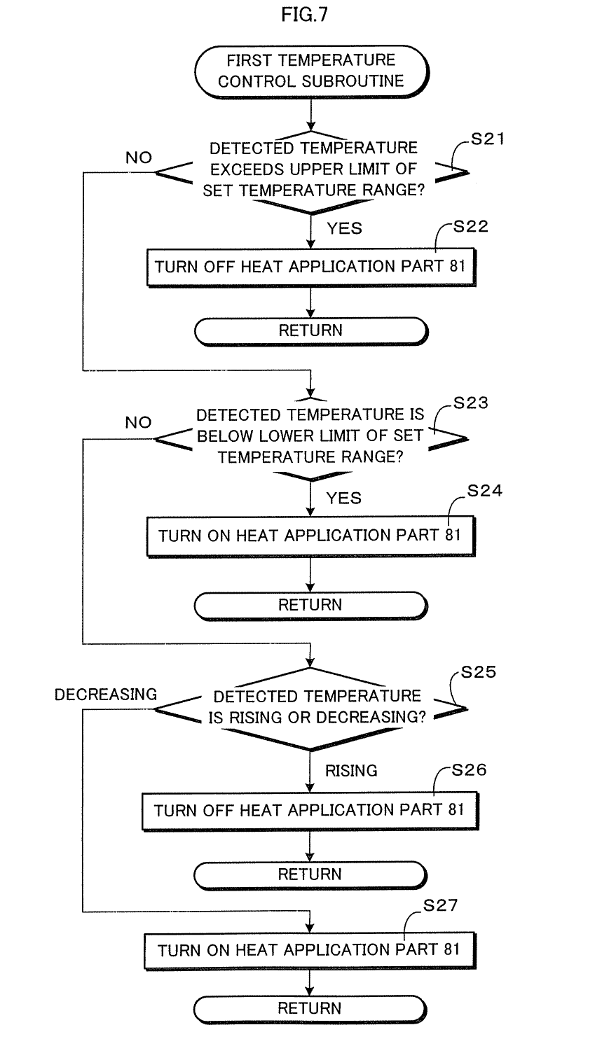

FIG. 7 shows procedures for the first temperature control subroutine in the first embodiment.

(1) The operation controller 84 judges whether the detected temperature detected by the temperature detector 83 exceeds the upper limit of the set temperature range or not (Step S21).

(2) When the detected temperature exceeds the upper limit of the set temperature range (Step S21: YES), the temperature controller 87 turns off the heat application part 81, and returns to the procedures in FIG. 6 (Step S22).

(3) When the detected temperature does not exceed the upper limit of the set temperature range (Step S21: NO), the temperature controller 87 judges whether the temperature detected by the temperature detector 83 is below the lower limit of the set temperature range (Step S23).

(4) When the detected temperature is below the lower limit of the set temperature range (Step S23: YES), the temperature controller 87 turns on the heat application part 81, and returns to the procedures in FIG. 6 (Step S24).

(5) When the detected temperature is equal to or higher than the lower limit of the set temperature range or higher (Step S23: NO), the temperature controller 87 judges whether the detected temperature is rising or decreasing (Step S25).

(6) When the detected temperature is rising (Step S25: rising), the temperature controller 87 turns off the heat application part 81, and returns to the procedures in FIG. 6 (Step S26).

(7) When the detected temperature is decreasing (Step S25: decreasing), the temperature controller 87 turns on the heat application part 81, and returns to the procedures in FIG. 6 (Step S27).

Verification of Results

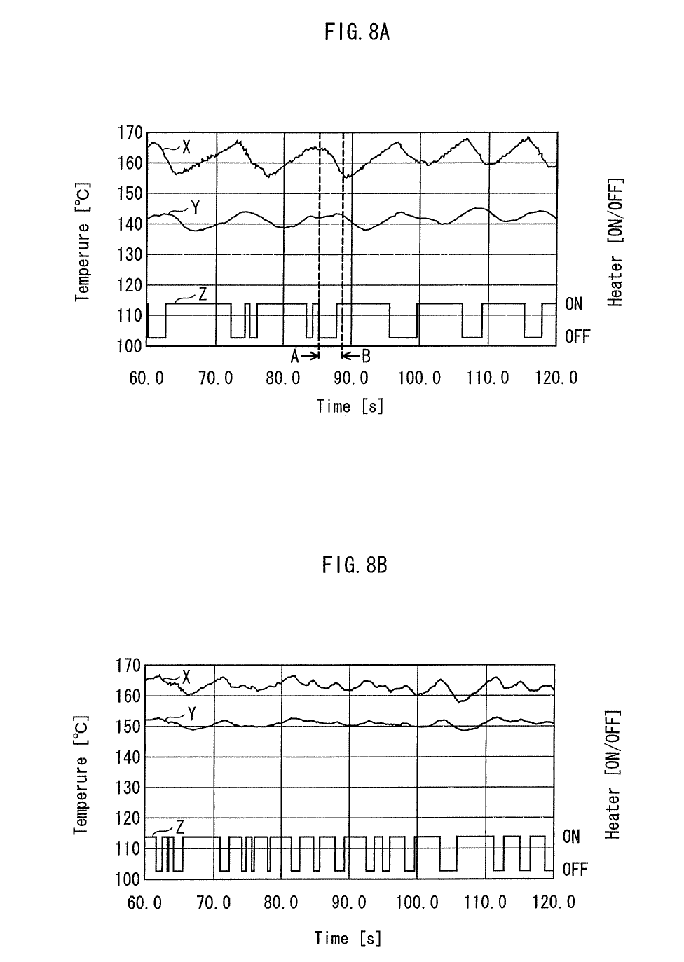

FIG. 8A shows observation results obtained after having actually measured a temperature of the fixing belt 53 and on-off states of the heater 55 when, for comparison, the temperature controller 87 performed only the first temperature control without performing the second temperature control when a sheet passes through, and FIG. 8B shows observation results obtained after having actually measured a temperature of the fixing belt 53 and on-off states of the heater 55 when the temperature controller 87 performed the first and second temperature control in the first embodiment, switching therebetween.

As shown in FIG. 8A and FIG. 8B, the upper linear graph (graph X) shows actual measurement values of the surface temperatures of the fixing belt 53 detected by the non-contact sensor, the middle linear graph (graph Y) shows correction values of the temperatures after the actual measurement values have been corrected according to characteristics of a sensor and the like, and the lower linear graph (graph Z) shows the on-off states of the heater 55.

In FIG. 8A, it is speculated, from the forms of the graph X and the graph Y, that the recording sheet has reached the fixing nip at timing shown by a broken line A. Although the temperature of the fixing belt 53 starts to drop at such a timing due to the load imposed when a sheet passes through the fixing nip, the temperature of the fixing belt 53 is excessively low at a timing shown by a broken like B because a time lag exists between a time at which the non-contact sensor detects a decrease in temperature and a time at which the temperature controller 87 turns on the heater 55. This causes uneven gloss in a page and the fixing faults.

On the other hand, in FIG. 8B, it can be seen, from the form of a graph Z, that on-off switching is performed frequently compared to FIG. 8A. Also, it can be seen, from the forms of graphs X and Y, that the temperature of the fixing belt 53 is so stable that it is difficult to speculate timing that the recording sheet has reached the fixing nip.

Note that although the heat start correspondence position is determined based on the position at which the heater 55 starts to apply heat (A in FIG. 4) in the first embodiment, the same effect can be obtained even if the heat start correspondence position is determined based on a position to which the heater 55 applies heat (distance between A and G in FIG. 4). For example, when the heat start correspondence position is obtained based on G in FIG. 4, the heat start correspondence position is located downstream from the reference position by a distance obtained by the following equation 3.

(distance between E and C)+(outer circumference of the heat application roller of the heat application roller×½)=84.4+(30×Π×½)≈131.5 (mm) equation 3

Accordingly, the heat start correspondence position may be in a position located downstream from the reference position by 84.4 (mm) to 131.5 (mm), according to the equations 2 and 3.

Conclusion

As described in the above, according to the first embodiment, since the temperature controller 87 keeps the heater on during a time period from a time when the leading end of the recording sheet has reached the heat start correspondence position until the detected temperature reaches the target temperature, the fixing nip is heated by a portion of the fixing belt which has been heated, when the leading end of the recording sheet has reached the fixing nip. This suppresses a drop in temperatures of the fixing belt and the fixing nip, caused by the load imposed when a sheet passes through the fixing nip. Also, excessive rise in such temperatures can be suppressed.

Accordingly, it is possible to solve the problem which is a delay in heat supply to the fixing nip when a sheet passes through the fixing nip, and overcome disadvantages such as uneven gloss in a page and the fixing faults.

Also, the temperature controller 87 continues to perform a normal temperature control (the first temperature control) if the heat source is on when the leading end of the recording sheet has reached the heat start correspondence position, thereby preventing an excessive rise in a temperature of the fixing position.

Also, even if the temperature controller 87 turns off the heat source because the detected temperature exceeds the target temperature after having turned on the heat source when the sheet has passed through, the temperature controller 87 turns on the heat source again when a time period during which the heat source is off exceeds a specified time period that possibly causes the fixing faults of the trailing end of the sheet. This can eliminate the fixing faults of the trailing ends of long sheets larger than A3-sized sheets, for example.

### (Modification 1)

Outline

Although a modification 1 is different from the first embodiment only in part of the temperature control performed by the temperature controller 87, other structure and operations of the modification 1 are the same as the first embodiment.

Structure

The temperature controller 87 in the modification 1 performs, as with the first embodiment, an on-off control on the heat application part 81 based on a temperature detected by the temperature detector 83: when in a standby state; or until the leading end detector 85 detects that the leading end of the recording sheet has passed through the heat start correspondence position.

The first temperature control 1 in the modification 1 is the same as the first temperature control in the first embodiment.

Also, as with the first embodiment, when the leading end detector detects that the leading end of the recording sheet has passed through the heat start correspondence position, the temperature controller 87 in the modification 1 performs the second temperature control for keeping the heat application part 81 on until the detected temperature reaches the target temperature in (i) a case when the detected temperature detected by the temperature detector 83 does not exceed the target temperature that is in a vicinity of the center of the set temperature range, and (ii) the fifth case when the heat application part 81 is off immediately before the detection (i.e. the first case and when the temperature is low in the immediately preceding first temperature control). Subsequently, when the detected temperature reaches the target temperature, the temperature controller 87 resumes the first temperature control.

Also, the modification 1 is different from the first embodiment in that the temperature controller 87 performs the second temperature control in the following cases at the time when the leading end detector 85 detects that the leading end of the recording sheet has passed through the heat start correspondence position: (i) a case when the detected temperature detected by the temperature detector 83 does not exceed the target temperature in a vicinity of the center of the set temperature range; and (ii) an eighth case when the heat application part 81 is on immediately before the detection (i.e. the third case and when the temperature is high in the immediately preceding first temperature control, or the fourth case). Subsequently, the temperature controller 87 (i) resumes the first temperature control when the detected temperature reaches the target temperature, and (ii) continues to perform the first temperature control in a ninth case when the detected temperature exceeds the target temperature (i.e. the first case and when the temperature is high in the immediately preceding first temperature control, the second case in the immediately preceding first temperature control, or the third case and when the temperature is high in the immediately preceding first temperature control).

Furthermore, in order to eliminate the fixing faults in the trailing ends of long sheets such as A3-sized sheets, the temperature controller 87 performs, as with the first embodiment, the following operations after the leading end detector 85 detects that the leading end of the recording sheet has passed through the heat start correspondence position. The temperature controller 87 counts a time period during which the heat application part is off (i) while the sheet detector 86 is detecting that the recording sheet is passing through or (ii) before the sheet detector 86 detects that the trailing end of the recording sheet has passed through the heat start correspondence position. The temperature controller 87 judges whether the detected temperature detected by the temperature detector 83 exceeds the target temperature when the counted time period exceeds a time period which has been pre-specified (two seconds in the modification 1). When the detected temperature detected by the temperature detector 83 does not exceed the target temperature, the temperature controller 87 stops performing the first temperature control, and resumes the second temperature control. Subsequently, the temperature controller 87 resumes the first temperature control when the detected temperature reaches the target temperature.

Operations

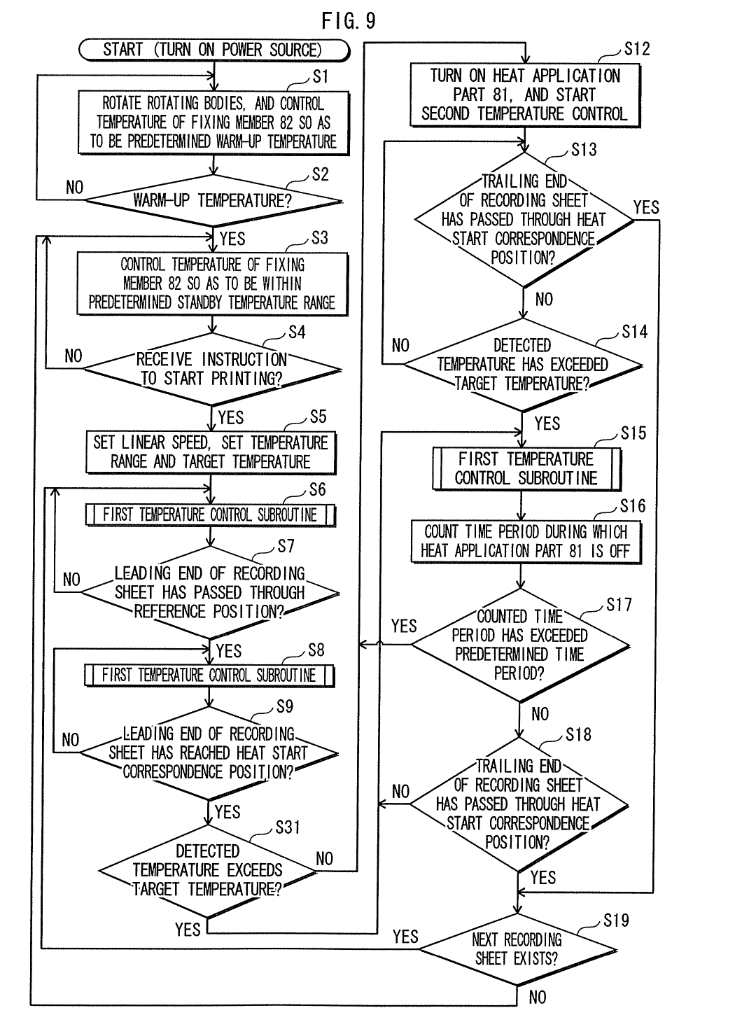

FIG. 9 shows procedures for controlling a temperature at the time of fixing in a first modification.

The following describes the procedures for controlling a temperature at the time of fixing using FIG. 9. Note that same reference numerals are assigned to steps performing the same procedures as the procedures in FIG. 6 in the first embodiment, omitting the description thereof.

(1) to (9) are the same processing as (1) to (9) in the first embodiment (Step S1 to Step S9).

(10) When the leading end of the recording sheet reaches the heat start correspondence position (C in FIG. 4) (Step S9: YES), the temperature controller 87 judges whether the detected temperature detected by the temperature detector 83 exceeds the target temperature (Step S31) as with (10) in FIG. 6. In the case of printing with normal setting with use of a normal sheet, for example, the temperature controller 87 judges whether or not the detected temperature exceeds 185° C.

(11) When the detected temperature does not exceed the target temperature (Step S31: NO), the temperature controller 87 performs the same processing as (12) in FIG. 6 in the first embodiment (Step S12).

(12) to (13) are the same processing as (13) to (14) in FIG. 6 in the first embodiment (Step S13 to Step S14).

(14) When the detected temperature exceeds the target temperature (Step S31: YES), and the detected temperature has exceeded the target temperature (Step S14: NO), the temperature controller 87 performs the same processing as (15) in FIG. 6 in the first embodiment (the first temperature control subroutine: Step S15).

(15) to (18) are the same processing as (16) to (19) in FIG. 6 in the first embodiment (Step S16 to Step S19).

Conclusion

As described in the above, according to the modification 1, since the temperature controller 87 keeps the heater on during a time period from a time when the leading end of the recording sheet has reached the heat start correspondence position until the detected temperature reaches the target temperature, the fixing nip is heated by a portion of the fixing belt which has been heated, when the leading end of the recording sheet has reached the fixing nip. This suppresses a drop in temperatures of the fixing belt and the fixing nip, caused by the load imposed when a sheet passes through the fixing nip. Also, excessive rise in such temperatures can be suppressed.

Accordingly, it is possible to solve the problem which is a delay in heat supply to the fixing nip when a sheet passes through the fixing nip, and overcome disadvantages such as uneven gloss in a page and the fixing faults.

Also, even if the heat source is on when the leading end of the recording sheet has reached the heat start correspondence position, the temperature controller 87 stops performing the normal temperature control (the first temperature control), and keeps the heat source on until the detected temperature reaches the target temperature (the second temperature control). This can prevent the temperature in the fixing position from rising excessively while suppressing a drop in the temperatures of the fixing belt and the fixing position, caused by the load imposed when a sheet passes through the fixing nip.

Also, even if the temperature controller 87 turns off the heat source because the detected temperature exceeds the target temperature after having turned on the heat source once when a sheet has passed through, the temperature controller 87 turns on the heat source again if a time period during which the heat source is off exceeds a specified time period that possibly causes the fixing fault of the trailing end of the sheet. This can eliminate the fixing faults of the trailing ends of long sheets larger than A3-sized sheets, for example.

### (Modification 2)

Although the modification 2 is different from the first embodiment only in part of the temperature control by the temperature controller 87, other structure and operations are the same as the first embodiment.

As with the first embodiment, the temperature controller 87 in the modification 2 performs the on-off control on the heat application part 81 based on a temperature detected by the temperature detector 83: when in a standby state; or until the leading end detector 85 detects that the leading end of the recording sheet has passed through the heat start correspondence position.

The first temperature control in the modification 2 is the same as the first temperature control in the first embodiment.

Also, the modification 2 is different from the first embodiment in that the temperature controller 87 performs the second temperature control for keeping the heat application part 81 on until the detected temperature reaches the upper limit of the set temperature range in the following cases at the time when the leading end detector 85 detects that the leading end of the recording sheet has passed through the heat start correspondence position: (i) a case when the detected temperature detected by the temperature detector 83 does not exceed the upper limit of the set temperature range; and (ii) a tenth case when the heat application part 81 is off immediately before the detection (i.e. the first case in the immediately preceding first temperature control). Subsequently, the temperature controller 87 resumes the first temperature control when the detected temperature reaches the upper limit of the set temperature range.

Also, the modification 2 is different from the first embodiment in that the temperature controller 87 in the modification 2 continues to perform the first temperature control in at least one of the following cases at the time when the leading end detector 85 detects that the leading end of the recording sheet has passed through the heat start correspondence position: (i) an eleventh case when the detected temperature detected by the temperature detector 83 exceeds the upper limit of the set temperature range (i.e. the second case in the immediately preceding first temperature control), and (ii) a twelfth case when the heat application part 81 is on immediately before the detection (i.e. the third case or the fourth case in the immediately preceding first temperature control).

Furthermore, in order to eliminate the fixing faults in the trailing ends of long sheets such as A3-sized sheets, the temperature controller 87 performs the following operations after the leading end detector 85 detects that the leading end of the recording sheet has passed through the heat start correspondence position. The temperature controller 87 counts a time period during which the heat application part 81 is off (i) while the sheet detector 86 is detecting that the recording sheet is passing through or (ii) before the sheet detector 86 detects that the trailing end of the recording sheet has passed through the heat start correspondence position. The temperature controller 87 judges whether the detected temperature detected by the temperature detector 83 exceeds the upper limit of the set temperature range when the counted time period exceeds a predetermined specified time period (two seconds in the modification 2). When the detected temperature does not exceed the upper limit of the set temperature range, the temperature controller 87 stops performing the first temperature control, and performs the second temperature control. Subsequently, the temperature controller 87 resumes the first temperature control when the detected temperature reaches the upper limit of the set temperature range.

Operations

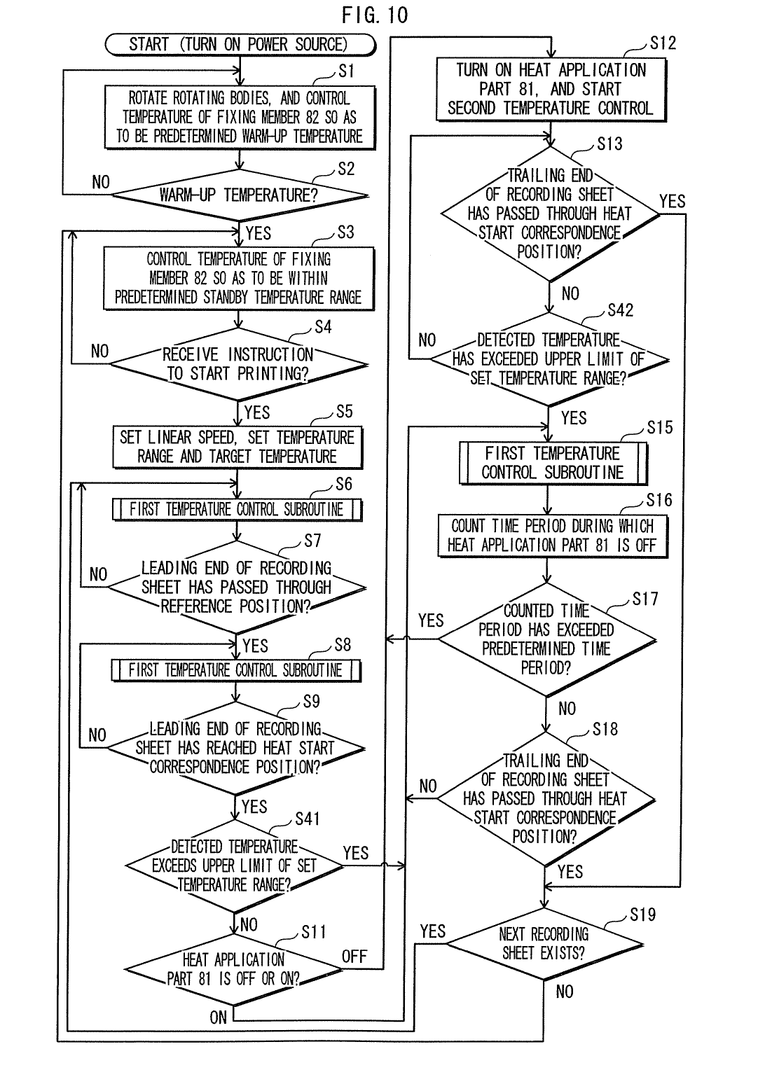

FIG. 10 shows procedures for controlling a temperature at the time of fixing in the modification 2.

The following shows the procedures for controlling the temperature at the time of fixing, using FIG. 10. Note that the reference numerals are assigned to steps performing the same procedures as the procedures in FIG. 6 in the first embodiment, omitting the description thereof.

(1) to (9) are the same processing as (1) to (9) in FIG. 6 in the first embodiment (Step S1 to Step S9).

(10) When the leading end of the recording sheet reaches the heat start correspondence position (C in FIG. 4) (Step S9: YES), the temperature controller 87 judges whether the detected temperature detected by the temperature detector 83 exceeds the upper limit of the set temperature range (Step S41). In the case of printing with normal setting with use of a normal sheet, for example, the temperature controller 87 judges whether or not the detected temperature exceeds 195° C.

(11) When the detected temperature does not exceed the upper limit of the set temperature range (Step S41: NO), the temperature controller 87 performs the same processing as (11) in FIG. 6 in the first embodiment (Step S11).

(12) to (13) are the same processing as (12) to (13) in FIG. 6 in the first embodiment (Step S12 to Step S13).

(14) The temperature controller 87 waits until the detected temperature detected by the temperature detector 83 in the second temperature control exceeds the upper limit of the set temperature range (Step S42).

(15) The temperature controller 87 performs the same processing as (15) in FIG. 6 in the first embodiment (the first temperature control subroutine: Step S15) in one of the following cases at the time when the leading end of the recording sheet has reached the heat start correspondence position (Step S9: YES): (i) the detected temperature exceeds the upper limit of the set temperature range (Step S41: YES); (ii) the detected temperature does not exceed the upper limit of the set temperature range (Step S41: NO) while the heat application part 81 is on (Step S11: ON); and (iii) the detected temperature exceeds the upper limit of the set temperature range due to the second temperature control (Step S42: YES).

(16) to (19) are the same processing as (16) to (19) in FIG. 6 in the first embodiment (Step S16 to Step S19).

Conclusion

As described in the above, according to the modification 2, since the temperature controller 87 keeps the heater on during a time period from a time when the leading end of the recording sheet has reached the heat start correspondence position until the detected temperature reaches the upper limit of the set temperature range, the fixing nip is heated by a portion of the fixing belt which has been heated, when the leading end of the recording sheet has reached the fixing nip. This suppresses a drop in temperatures of the fixing belt and the fixing nip, caused by the load imposed when a sheet passes through the fixing nip. Also, excessive rise in such temperatures can be suppressed.

Accordingly, it is possible to solve the problem which is a delay in heat supply to the fixing nip when a sheet passes through the fixing nip, and overcome disadvantages such as uneven gloss in a page and the fixing faults.

Also, the temperature controller 87 continues to perform the normal temperature control (the first temperature control) if the heat source is on when the leading end of the recording sheet has reached the heat start correspondence position, thereby preventing an excessive rise in a temperature of the fixing position.

Also, even if the temperature controller 87 turns off the heat source because the detected temperature exceeds the upper limit of the set temperature range after having turned on the heat source when the sheet has passed through, the temperature controller 87 turns on the heat source again when a time period during which the heat source is off exceeds a specified time period that possibly causes the fixing faults of the trailing end of the sheet. This can eliminate the fixing faults of the trailing ends of long sheets larger than A3-sized sheets, for example.

### (Modification 3)

Although the modification 3 is different from the first embodiment only in part of the temperature control by the temperature controller 87, other structure and operations are the same as the first embodiment.

The temperature controller 87 in the modification 3 performs, as with the first embodiment, the first temperature control which is an on-off control on the heat application part 81 based on a temperature detected by the temperature detector 83: when in a standby state; or until the leading end detector 85 detects that the leading end of the recording sheet has passed through the heat start correspondence position.

The first temperature control in the modification 3 is the same as the first temperature control in the first embodiment.

Also, the modification 3 is different from the first embodiment in that the temperature controller 87 in the modification 3 performs the second temperature control for keeping the heat application part 81 on until the detected temperature reaches the upper limit of the set temperature range in the following cases at the time when the leading end detector 85 detects that the leading end of the recording sheet has passed through the heat start correspondence position: (i) the detected temperature detected by the temperature detector 83 does not exceed the upper limit of the set temperature range, and (ii) the heat application part 81 is off immediately before the detection (the tenth case) (i.e. the first case in the immediately preceding first temperature control). Subsequently, the temperature controller 87 resumes the first temperature control when the detected temperature reaches the upper limit of the set temperature range.

Also, the modification 3 is different from the first embodiment in that the temperature controller 87 in the modification 3 performs the second temperature control when the leading end detector 85 detects that the leading end of the recording sheet has passed through the heat start correspondence position in a thirteenth case when the detected temperature detected by the temperature detector 83 does not exceeds the upper limit of the set temperature range(i.e. the third case or the fourth case in the immediately preceding first temperature control). Subsequently, the temperature controller 87 (i) resumes the first temperature control if the detected temperature reaches the upper limit of the set temperature range, and (ii) continues to perform the first temperature control in a fourteenth case when the detected temperature exceeds the upper limit of the set temperature range (i.e. the second case in the immediately preceding first temperature control).

Furthermore, in order to eliminate the fixing faults in the trailing ends of long sheets such as A3-sized sheets, the temperature controller 87 performs the following operations after the leading end detector 85 detects that the leading end of the recording sheet has passed through the heat start correspondence position. The temperature controller 87 counts a time period during which the heat application part 81 is off (i) while the sheet detector 86 is detecting that the recording sheet is passing through or (ii) before the sheet detector 86 detects that the trailing end of the recording sheet has passed through the heat start correspondence position. The temperature controller 87 judges whether the detected temperature detected by the temperature detector 83 exceeds the upper limit of the set temperature range when the counted time period exceeds a predetermined specified time period (two seconds in the modification 3). When the detected temperature does not exceed the upper limit of the set temperature range, the temperature controller 87 stops performing the first temperature control, and performs the second temperature control. Subsequently, the temperature controller 87 resumes the first temperature control when the detected temperature reaches the upper limit of the set temperature range.

Operations

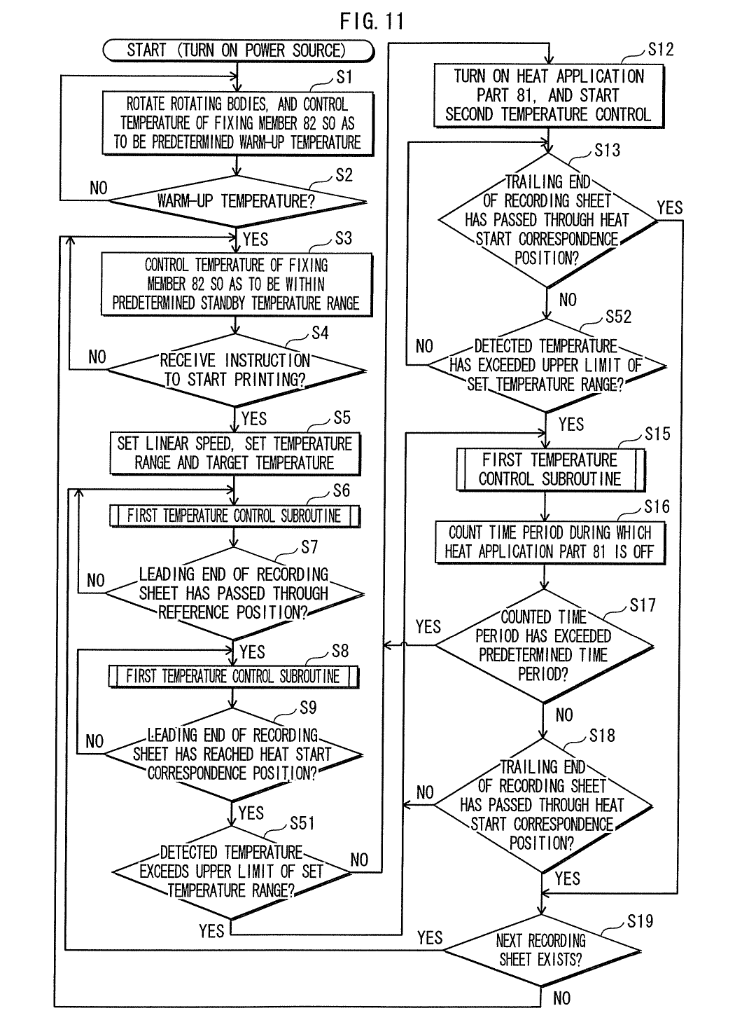

FIG. 11 shows procedures for controlling a temperature at the time of fixing in the modification 3.

The following shows the procedures for controlling the temperature at the time of fixing, using FIG. 11. Note that the reference numerals are assigned to steps performing the same procedures as the procedures in FIG. 6 in the first embodiment, omitting the description thereof. (1) to (9) are the same processing as (1) to (9) in FIG. 6 in the first embodiment (Step S1 to Step S9).

(10) When the leading end of the recording sheet reaches the heat start correspondence position (C in FIG. 4) (Step S9: YES), the temperature controller 87 judges whether the detected temperature detected by the temperature detector 83 exceeds the upper limit of the set temperature range (Step S51). In the case of printing with normal setting with use of a normal sheet, for example, the temperature controller 87 judges whether or not the detected temperature exceeds 195° C.

(11) When the detected temperature does not exceed the upper limit of the set temperature range (Step S51: NO), the temperature controller performs the same processing as (12) in FIG. 6 in the first embodiment (Step S12).

(12) The same processing as (13) in FIG. 6 in the first embodiment is performed (Step S13).

(13) The temperature controller 87 waits until the detected temperature detected by the temperature detector 83 in the second temperature control exceeds the upper limit of the set temperature range (Step S52).

(14) The temperature controller 87 performs the same processing as (15) in FIG. 6 in the first embodiment (the first temperature control subroutine: Step S15) in (i) a case when the detected temperature exceeds the upper limit of the set temperature range (Step S51: YES), and (ii) a case when the detected temperature has exceeded the upper limit of the set temperature range due to the second temperature control (Step S52: YES).

(15) to (18) are the same processing as (16) to (19) in FIG. 6 in the first embodiment (Step S16 to Step S19).

Conclusion

As described in the above, according to the modification 3, since the temperature controller 87 keeps the heater on during a time period from a time when the leading end of the recording sheet has reached the heat start correspondence position until the detected temperature reaches the upper limit of the set temperature range, the fixing nip is heated by a portion of the fixing belt which has been heated, when the leading end of the recording sheet has reached the fixing nip. This suppresses a drop in temperatures of the fixing belt and the fixing nip, caused by the load imposed when a sheet passes through the fixing nip. Also, excessive rise in such temperatures can be suppressed.

Accordingly, it is possible to solve the problem which is a delay in heat supply to the fixing nip when a sheet passes through the fixing nip, and overcome disadvantages such as uneven gloss in a page and the fixing faults.

Also, the temperature controller 87 (i) stops performing the normal temperature control (the first temperature control) even if the heat source is on when the leading end of the recording sheet reaches the heat start correspondence position, and (ii) keeps the heat source on until the detected temperature reaches the upper limit of the set temperature range (the second temperature control). This can prevent the temperature in the fixing position from rising excessively while suppressing a drop in the temperatures of the fixing belt and the fixing position, caused by the load imposed when a sheet passes through the fixing nip.

Also, even if the temperature controller 87 turns off the heat source because the detected temperature exceeds the upper limit of the set temperature range after having turned on the heat source once when a sheet has passed through, the temperature controller 87 turns on the heat source again if a time period during which the heat source is off exceeds a specified time period that possibly causes the fixing faults of the trailing end of the sheet. This can eliminate the fixing faults of the trailing ends of long sheets larger than A3-sized sheets, for example.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. An image formation apparatus that (i) includes a fixing member including (a) a heat application roller and (b) a fixing belt that is wound around the heat application roller such that a portion of the fixing belt in a heat application position is heated by a heat source via the heat application roller, and (ii) thermally fixes, with use of the fixing member, an unfixed image formed on a recording sheet conveyed along a conveyance path to a fixing position that is a position to which the portion of the fixing belt travels to supply heat to the unfixed image, the image formation apparatus comprising:
a temperature detector operable to detect a temperature of the fixing member;
a leading end detector operable to detect a timing that a leading end of the recording sheet passes through a predetermined position on the conveyance path, the predetermined position being a position located upstream in the conveyance path from the fixing position by a distance that is equivalent to a distance that a portion of the fixing belt that has been heated in the heat application position travels to the fixing position; and
a temperature controller operable to perform (i) a first temperature control which is anon-off control of the heat source based on the temperature detected by the temperature detector, and (ii) a second temperature control for keeping the heat source on until the detected temperature reaches the predetermined switching temperature, wherein
the temperature controller (i) performs the first temperature control until the leading end detector detects that the leading end of the recording sheet has passed through the predetermined position, (ii) performs the second temperature control in a case when the leading end detector detects that the leading end of the recording sheet has passed through the predetermined position if (a) the detected temperature does not exceed a predetermined switching temperature, and (b) the heat source is off, and (iii) resumes the first temperature control in a case when the detected temperature reaches the predetermined switching temperature.

2. The image formation apparatus of claim 1, further comprising,
a sheet detector operable to detect whether or not the recording sheet is passing through a certain position located upstream from the fixing position on the conveyance path, wherein
the temperature controller (i) further performs, after the leading end detector has performed the detection, the second temperature control if (a) a time period during which the heat source is off exceeds a predetermined specified time period while the sheet detector is detecting that the recording sheet is passing through the certain position, and (b) the temperature detected by the temperature detector does not exceed the predetermined switching temperature, and (ii) resumes the first temperature control in a case when the detected temperature reaches the predetermined switching temperature.

3. The image formation apparatus of claim 1, wherein
when performing the first temperature control, the temperature controller (i) turns off the heat source in one of: a case when the temperature detected by the temperature detector is within a set temperature range, and is rising; and a case when the detected temperature exceeds an upper limit of the set temperature range, and (ii) turns on the heat source in one of: a case when the detected temperature is within the set temperature range, and is decreasing; and a case when the detected temperature is below a lower limit of the set temperature range.

4. The image formation apparatus of claim 3, wherein
the predetermined switching temperature is a target temperature in a vicinity of a center of the set temperature range, and
in a case when the leading end detector detects that the leading end of the recording sheet has passed through the predetermined position, the temperature controller continues to perform the first temperature control in at least one of (i) a case when the detected temperature exceeds the target temperature, and (ii) a case when the heat source is on.

5. The image formation apparatus of claim 3, wherein
the predetermined switching temperature is a target temperature in a vicinity of a center of the set temperature range,
in a case when the leading end detector detects that the leading end of the recording sheet has passed through the predetermined position, the temperature controller (i) performs the second temperature control if the detected temperature does not exceed the target temperature, and the heat source is on, and (ii) resumes the first temperature control in a case when the detected temperature reaches the target temperature, and
in a case when the leading end detector detects that the leading end of the recording sheet has passed through the predetermined position, the temperature controller continues to perform the first temperature control if the detected temperature exceeds the target temperature.

6. The image formation apparatus of claim 3, wherein
the predetermined switching temperature is an upper limit of the set temperature range, and
in a case when the leading end detector detects that the leading end of the recording sheet has passed through the predetermined position, the temperature controller continues to perform the first temperature control in at least one of (i) a case when the detected temperature exceeds the upper limit of the set temperature range, and (ii) a case when the heat source is on.

7. The image formation apparatus of claim 3, wherein
the predetermined switching temperature is an upper limit of the set temperature range,
in a case when the leading end detector detects that the leading end of the recording sheet has passed through the predetermined position, the temperature controller (i) performs the second temperature control if the detected temperature does not exceed the upper limit of the set temperature range, and the heat source is on, and (ii) resumes the first temperature control in a case when the detected temperature reaches the upper limit of the set temperature range, and
in a case when the leading end detector detects that the leading end of the recording sheet has passed through the predetermined position, the temperature controller continues to perform the first temperature control if the detected temperature exceeds the upper limit of the set temperature range.

8. An image formation method used in an image formation apparatus that detects a temperature of a fixing member with use of a temperature detector, so as to thermally fixes, with use of the fixing member, an unfixed image formed on a recording sheet conveyed along a conveyance path to a fixing position, the fixing member including (a) a heat application roller and (b) a fixing belt that is wound around the heat application roller such that a portion of the fixing belt in a heat application position being heated by a heat source via the heat application roller, and the fixing position being a position to which the portion of the fixing belt travels to supply heat to the unfixed image, the image formation method comprising:
a leading end detecting step of detecting a timing that a leading end of the recording sheet passes through a predetermined position on the conveyance path, the predetermined position being a position located upstream in the conveyance path from the fixing position by a distance that is equivalent to a distance that a portion of the fixing belt that has been heated in the heat application position travels to the fixing position; and
a temperature controlling step of performing (i)a first temperature control which is an on-off control of the heat source based on the temperature detected by the temperature detecting step, and (ii) a second temperature control for keeping the heat source on until the detected temperature reaches the predetermined switching temperature, wherein
the temperature controlling step (i) performs the first temperature control until the leading end detecting step detects that the leading end of the recording sheet has passed through the predetermined position, (ii) performs the second temperature control in a case when the leading end detecting step detects that the leading end of the recording sheet has passed through the predetermined position if (a) the detected temperature does not exceed a predetermined switching temperature, and (b) the heat source is off, and (iii) resumes the first temperature control in a case when the detected temperature reaches the predetermined switching temperature.

9. The image formation method of claim 8, further comprising,
a sheet detecting step of detecting whether or not the recording sheet is passing through a certain position located upstream from the fixing position on the conveyance path, wherein
the temperature controlling step (i) further performs, after the leading end detecting step has performed the detection, the second temperature control if (a) a time period during which the heat source is off exceeds a predetermined specified time period while the sheet detecting step is detecting that the recording sheet is passing through the certain position, and (b) the temperature detected by the temperature detecting step does not exceed the predetermined switching temperature, and (ii) resumes the first temperature control in a case when the detected temperature reaches the predetermined switching temperature.

10. The image formation method of claim 9, wherein
when performing the first temperature control, the temperature controlling step (i) turns off the heat source in one of: a case when the temperature detected by the temperature detecting step is within a set temperature range, and is rising; and a case when the detected temperature exceeds an upper limit of the set temperature range, and (ii) turns on the heat source in one of: a case when the detected temperature is within the set temperature range, and is decreasing; and a case when the detected temperature is below a lower limit of the set temperature range.

11. The image formation method of claim 10, wherein
the predetermined switching temperature is a target temperature in a vicinity of a center of the set temperature range, and
in a case when the leading end detecting step detects that the leading end of the recording sheet has passed through the predetermined position, the temperature controlling step continues to perform the first temperature control in at least one of a case when the detected temperature exceeds the target temperature, and a case when the heat source is on.

12. The image formation method of claim 10, wherein
the predetermined switching temperature is a target temperature in a vicinity of a center of the set temperature range,
in a case when the leading end detecting step detects that the leading end of the recording sheet has passed through the predetermined position, the temperature controlling step (i) performs the second temperature control if the detected temperature does not exceed the target temperature, and the heat source is on, and (ii) resumes the first temperature control in a case when the detected temperature reaches the target temperature, and
in a case when the leading end detecting step detects that the leading end of the recording sheet has passed through the predetermined position, the temperature controlling step continues to perform the first temperature control if the detected temperature exceeds the target temperature.

13. The image formation method of claim 10, wherein
the predetermined switching temperature is an upper limit of the set temperature range, and
in a case when the leading end detecting step detects that the leading end of the recording sheet has passed through the predetermined position, the temperature controlling step continues to perform the first temperature control in at least one of (i) a case when the detected temperature exceeds the upper limit of the set temperature range, and (ii) a case when the heat source is on.

14. The image formation method of claim 10, wherein
the predetermined switching temperature is an upper limit of the set temperature range,
in a case when the leading end detecting step detects that the leading end of the recording sheet has passed through the predetermined position, the temperature controlling step (i) performs the second temperature control if the detected temperature does not exceed the upper limit of the set temperature range, and the heat source is on, and (ii) resumes the first temperature control in a case when the detected temperature reaches the upper limit of the set temperature range, and
in a case when the leading end detecting step detects that the leading end of the recording sheet has passed through the predetermined position, the temperature controlling step continues to perform the first temperature control if the detected temperature exceeds the upper limit of the set temperature range.

15. A computer readable recording medium that provides an image formation program that causes an image formation apparatus to form an image, the image formation apparatus detecting a temperature of a fixing member with use of a temperature detector, so as to thermally fixes, with use of the fixing member, an unfixed image formed on a recording sheet conveyed along a conveyance path to a fixing position, the fixing member including (a) a heat application roller and (b) a fixing belt that is wound around the heat application roller such that a portion of the fixing belt in a heat application position being heated by a heat source via the heat application roller, and the fixing position being a position to which the portion of the fixing belt travels to supply heat to the unfixed image, the image formation program causing a computer to perform:
a temperature controlling step of performing (i)a first temperature control which is an on-off control of the heat source based on the temperature detected by the temperature detecting step, and (ii) a second temperature control for keeping the heat source on until the detected temperature reaches the predetermined switching temperature, wherein
the temperature controlling step (i) performs the first temperature control until the leading end detecting step detects that the leading end of the recording sheet has passed through the predetermined position, (ii) performs the second temperature control in a case when the leading end detecting step detects that the leading end of the recording sheet has passed through the predetermined position if (a) the detected temperature does not exceed a predetermined switching temperature, and (b) the heat source is off, and (iii) resumes the first temperature control in a case when the detected temperature reaches the predetermined switching temperature.
